(19) United States
(12) Patent Application Publication
(10) Pub. No.: US 2011/0088511 A1
(43) Pub. Date: Apr. 21, 2011

(54) METHOD FOR PRODUCING ROD-SHAPED AND BRANCHED METALLIC NANO-STRUCTURES BY POLYOL COMPOUNDS

(76) Inventors: Ghanavi Jalaledin, TEHRAN (IR); Mostafavi Mehrnaz, TEHRAN (IR)

(21) Appl. No.: 12/870,792

(22) Filed: Aug. 28, 2010

(51) Int. Cl. B22F 9/18; B82Y 30/00

(52) U.S. Cl. 75/345; 75/343; 977/896

(57) ABSTRACT

The various embodiments herein provide method of producing a rod-shape and branched metal nano-structures with polyol compounds as a reducing agent. The metal nano-structures are produced in a closed chamber of microwave system with variable irradiation power at a designed temperature. The metal nano-structures produced exhibits localized plasmon-polariton resonance, exhibit spectral resonance positions at microwave or radio frequencies and exhibit multiple spectral resonance peak at microwave or radio frequencies. The metal nano-structures produced are suitable as a coating composition material, a coating, a film, a wiring material, an electrode material, a catalyst, a colorant, a cosmetic, a near-infrared absorber, an anti-counterfeit ink and an electromagnetic shielding material, a surface enhanced fluorescent sensor, a biomarker and a nano-waveguide.

### BACKGROUND

1. Technical Field

The embodiments herein generally relates to a method of producing nanostructures. The embodiments herein particularly relates to a method for producing rod-shaped and branched metallic nano-structures that excel in optical absorption properties in a region extending from visible light to microwave or radio frequencies. The embodiments herein more particularly relates to a technology for suppressing a production of spherical metal nano-particles and a technology for controlling a configuration of the generated rod-shaped and branched metallic nano-structures so as to design its spectral characteristics.

2. Description of the Related Art

A nanostructure is an object of intermediate size between molecular and microscopic (micrometer-sized) structures. When describing the nanostructures, it is necessary to differentiate between the numbers of dimensions on the nanoscale. Nanotextured surfaces have one dimension on the nanoscale, with thickness of the surface of an object ranging between 0.1 and 100 nm. Nanotubes have two dimensions on the nanoscale, with the diameter of the tube ranging between 0.1 and 100 nm and its length could be much greater. Then the spherical nano particles have three dimensions on the nanoscale, with the particle ranging between 0.1 and 100 nm in each spatial dimension. The term ‘nanostructure’ is often used when referring to magnetic technology.

A nano-rod is one among the various types of nano-structures, with the dimension ranging from 1-100 nm. The nano rods may be synthesized from metals or semiconducting materials. The standard aspect ratios of nano-rods (length divided by width) are 3-5. Nano-rods are produced by direct chemical synthesis. A combination of ligands acts as the shape control agents and bond to different facets of the nano-rod with different strengths. This allows the different faces of the nano-rod to grow at different rates, producing an elongated object.

A direct chemical synthesis and a combination of ligands are all that are required for production and shape control of the nano-rods. Ligands also bond to different facets of the nano-rod with varying strengths. In such a way, the different faces of nano-rods are made to grow at different rates, thereby producing an elongated object of a certain desired shape.

Gold nano-particles in shape of a rod (gold nano-rods) with uniform configuration have a strong absorption band in a region extending from visible light to microwave or radio frequencies rays, and there is a possibility to change the absorption peak positions of gold nano-rods easily by controlling configuration thereof. Gold nano-rods have a high aptitude as near-infrared probes because modification of their surface enables change of their physical properties.

As for the methods of manufacturing gold nano-rods, an electrolytic method, a chemical reduction method and a photo-reduction method are conventionally known. With the electrolytic method, a solution containing a cationic surfactant is electrolyzed by constant current and gold clusters are leached from a gold plate at the anode, thereby generating gold nano-rods. For the above-mentioned surfactant, a quaternary ammonium salt having a structure containing four hydrophobic substituents is bonded to a nitrogen atom is used.

In addition, tetradodecylammonium bromide (TDAB), a compound in which an autonomous molecular assembly is not formed, is added. During the manufacturing of the gold nano-rods, the source of gold supply is a cluster of gold that are leached from a gold plate at the anode, but gold salt such as chlorauric acid is not used. During electrolysis, a gold plate is immersed in the solution which is irradiated with ultrasonic waves to accelerate the growth of the gold nano-rods.

During the electrolytic method, the change in the area of the gold plate to be immersed separately from an electrode enables the controlling of the length of the rod to be generated. The adjustment of the rod length enables the setting of the absorption band in the near-infrared region from the vicinity of 700 nm to the vicinity of 1200 nm. If the reaction condition is uniformly maintained, gold nano-rods with a uniform configuration can be manufactured to an extent. However, the surfactant solution used for the electrolysis is a complex system containing excessive quaternary ammonium salt, cyclohexane and acetone, and because of indefinite elements, such as ultrasound wave radiation, it is difficult to theoretically analyze a cause-effect relationship between the configuration of the gold nano-rods to be generated and various manufacturing conditions, and to optimize the manufacturing conditions for the gold nano-rods. Furthermore, because of the nature of the electrolysis, it is not easy to scale up, making it unsuitable for the large-scale manufacture of gold nano-rods.

With the chemical reduction method, NaBH.sub.4 reduces chlorauric acid and nano-particles are generated. Considering these gold nano-particles as “seed particles” and growing them in the solution results in obtaining the gold nano-rods. The length of the gold nano-rods to be generated is determined according to the quantitative ratio of the “seed particles” to the chlorauric acid added to the growth solution. With the chemical reduction method, it is possible to generate longer gold nano-rods in comparison with the above-described electrolytic method. A gold nano-rod having an absorption peak in the near-infrared region over 1200 nm is reported.

As described previously, in the chemical reduction method, two reaction baths for the preparation and reaction to grow the “seed particles” are required. Furthermore, although the generation of the “seed particles” is completed in several minutes, it is difficult to increase the concentration of the gold nano-rods generated, and the generation concentration of the gold nano-rods is one-tenth or less in comparison with that when using the electrolytic method.

In the photo-reduction method, chlorauric acid is added to substantially the same solution as that in the electrolytic method, and ultraviolet irradiation results in the reduction of the chlorauric acid. For irradiation, a low-pressure mercury lamp is used. In the photo-reduction method, gold nano-rods can be generated without producing seed particles. It is possible to control the length of the gold nano-rods by the irradiation time. This method is characterized by the excellent uniform configuration of the gold nano-rods generated.

With the electrolytic method, a large quantity of spherical particles coexist after reaction, therefore it is necessary to separate the spherical particles by centrifugation.

However, the separation process is unnecessary in the photo-reduction method, since the ratio of the spherical particles is small. Furthermore, there are certain advantages, for example, the reproducibility is excellent and gold nano-rods of the same size can be almost certainly obtained using a standard operation.

In the meantime, the photo-reduction method requires 10 hours or more for the reaction. Furthermore, the particles having an absorption peak at a position of over 800 nm cannot be obtained. In addition, there is an additional problem in the process and the problem is that the light from the low-pressure mercury lamp is harmful to the human body.

The tunable NIR absorbance of gold in conjunction with its low cytotoxicity has fueled research in the synthesis of rodlike gold nanocrystals for a wide range of biomedical applications such as sensing, imaging, and photothermal therapy. However, a fundamental problem in the realization of these technologies is the need for (cytotoxic) surfactants—such as cetyltrimethylammonium bromide (CTAB)—in order to induce the anisotropic particle growth in aqueous solution. Herein we present an alternate synthetic strategy based polyol compound that alleviates the need for shape-regulating.

Hence there is a need for an efficient, inexpensive, eco-friendly method of producing rod-shape and branched metallic nano-structures in which the time period required for producing rod-shape and branched metallic nano-structures can be drastically shortened and significant acceleration of producing rod-shape and branched gold nano-structures can be realized.

The above mentioned shortcomings, disadvantages and problems are addressed herein and which will be understood by reading and studying the following specification.

### OBJECTIVES OF THE EMBODIMENTS

The primary object of the embodiments herein is to provide a simple and an efficient method of producing rod-shaped and branched metallic nano-structures by using polyol compounds as reducing agent.

Another object of the embodiments herein is to provide a method of producing rod-shape and branched metallic nano-structures for suppressing the generation of spherical metal nano-particles.

Yet another object of the embodiments herein is to provide a method of producing and controlling a configuration of rod-shaped and branched metallic nano-structures to design its spectral characteristics.

Yet another object of the embodiments herein is to provide a method of producing rod-shaped and branched metallic nano-structures in a short period of time by shortening the photo-reaction process.

Yet another object of the embodiments herein is to provide a method of producing rod-shaped and branched metallic nano-structures with significant acceleration.

Yet another object of the embodiments herein is to manufacture rod-shaped and branched metallic nano-structures with target wavelength absorption characteristics efficiently.

Yet another object of the embodiments herein is to provide a method of producing rod-shaped and branched metallic nano-structures without requiring the templates.

Yet another object of the embodiments herein is to provide a method of producing rod-shaped and branched metallic nano-structures with a short crystallization time.

Yet another object of the embodiments herein is to provide a method of producing rod-shaped and branched metallic nano-structures without requiring a further fractionation and purification process after reaction.

Yet another object of the embodiments herein is to provide a method of producing rod-shaped and branched metallic nano-structures with an easy configuration control method for the metallic nano-structures.

Yet another object of the embodiments herein is to provide a method of producing rod-shape and branched metallic nano-structures quickly and easily.

Yet another object of the embodiments herein is to provide an economical and eco-friendly method of producing rod-shape and branched metallic nano-structures.

Yet another object of the embodiments herein is to provide a method of producing rod-shape and branched metallic nano-structures that can be used for materials for a surface enhanced fluorescent sensor, a biomarker and a nano-waveguide.

These and other objects and advantages of the embodiments herein will become readily apparent from the following detailed description taken in conjunction with the accompanying drawings.

### SUMMARY

The various embodiments herein provide a rod-shape and branched metal nano-structures. According to one embodiment, polyol compound as a reducing agent is the most integral component. The method of producing, as mentioned in the embodiments herein, provides more efficient metal nano-structures that exhibit spectral resonance positions at microwave or radio frequencies and exhibit multiple spectral resonance peaks at microwave or radio frequencies.

According to one embodiment herein, a method of producing a rod-shape and branched metal nano-structure, comprises mixing of a metal salt and a solvent to form a metal salt solution, wherein the metal salt solution is maintained at or below 50° C. or at an ambient temperature; chemically reducing the metal salt solution by adding a reducing agent, wherein the reducing agent is a polyol compound with a chemical formula HO—CH2-(CH2-O—CH2-) n-CH2-OH—; radiating the metal salt solution to a preset temperature, wherein the preset temperature is a reaction temperature between 100° C. to about 340° C. under a microwave in a continuous wave mode or in a pulse mode at a preset power of intensity between 600 W-2200 W, wherein a radiation time is 2-30 minutes; radiating a reducing solvent, wherein the reducing solvent comprises a mixture of polyol compounds under a microwave at a preset temperature, wherein the preset temperature is a reaction temperature of less than or equal to 340° C. in a continuous wave mode or in a pulse mode at a preset power of intensity, wherein a radiation time is 4-8 minutes till the reduction process is complete and a metal nanoparticles are generated; cooling the metal salt solution containing the metal nano-particles at a room temperature; precipitating the metal nano-particles by adding a solvent; washing of the metal nano-particles with the solvent several times; collecting the metal nano-particle precipitates for analysis; performing re-precipitation using a methanol or distilled water; and determining the length and diameter of the obtained nano-structures by transmission electron microscopy (TEM).

According to one embodiment herein, the method of producing the metal nano-structures comprises reducing chemically a metal salt in a solution using a reducing agent as one step and irradiating microwave into a solution containing a chemically reduced metal salt at a variable irradiation power and at a designed temperature as another step to obtain a rod-shape and branched metal nano-structure.

According to one embodiment herein, the metal salt solution comprises a reducing agent and a metallic salt. The reducing agent is a polyol compound that acts as a stabilizer of the metal nano-structures. The polyol compound accelerates the major axis growth of the metal nano-structures. The polyol compound is selected so as the metal nano-structure precursors are non-volatile at an irradiation temperature. The polyol compound may be a single polyol or a combination of two or more polyols.

According to one embodiment herein, the metal salt is selected from a group of compounds of gold, copper, nickel, cobalt, platinum, palladium and their alloys, most preferably selected from a group of gold compounds. The molar concentration of the gold compound is preferably between 0.1M-3.0M.

According to one embodiment herein, the metal salt solution further comprises a solvent to dissolve the gold compound to form a gold solution. The solvent may be a single solvent or a mixture of two or more solvents individually or collectively.

The gold solution is maintained at or below 50° C., at or below 40° C., at or below 30° C. or at an ambient temperature.

The metal salt solution is reacted on a microwave system at a variable irradiation power for a designed temperature. The irradiation power is maintained 600-2200 W. The reaction temperature is maintained 100° C. to about 340° C. The reaction temperature is directly proportional to the diameter of the metal nano-structure. The metal salt solution is reacted under microwave (MW) heating in a continuous wave (CW) or a pulse mode for 2-30 min.

The metal nano-structures have a particular absorption characteristic in a wavelength region from 700 nm to 2,500 nm. The reaction time to obtain the metal nano-structure is 1-2 minutes or a week.

According to one embodiment herein, the configuration of the metal nano-structures is controlled by adjusting the polyol compound; added amount of the surfactant; an amount of the polyol compound; microwave irradiation intensity and light irradiation time.

According to one embodiment herein, the microwave irradiation intensity is 310 nm or less. The irradiation time is 2 to 30 minutes. The irradiation time is directly proportional to the length of the metal nano-structure.

According to one embodiment herein, the method of producing the metal nano-structures further comprises tuning a first plasmon-polariton resonance across a first axis of the rod-shape and branched metal nano-structures to a first wavelength and tuning a second plasmon-polariton resonance across a second axis of the rod-shape and branched metal nano-structures to a second wavelength.

According to one embodiment herein, the metal nano-structures exhibit multiple resonances spectral range. The metal nano-structures exhibit a spectral resonance positions at microwave or radio frequencies.

According to one embodiment herein, a configuration of metal nano-structures is a metallic nano-rod, a metallic nano-ellipsoid, a metallic nano-wire, a metallic nano-branched and a metallic nano-multi-pod.

According to one embodiment herein, the metal nano-structures produced are used as a coating composition material, a coating, a film, a wiring material, an electrode material, a catalyst, a colorant, a cosmetic, a near-infrared absorber, an anti-counterfeit ink and an electromagnetic shielding material, a surface enhanced fluorescent sensor, a biomarker and a nano-waveguide.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flow chart explaining the method of producing the rod-shape and branched metal nano-structures, according to one embodiment.

FIG. 2 illustrates a flow chart explaining the method of producing the rod-shape and branched metal nano-structures, according to one embodiment.

FIG. 3A illustrates a TEM image of the gold rod-shape and branched nano-structures of 110 nm produced by a method disclosed in the Example 1.

FIG. 3B illustrates a TEM image of the gold rod-shape nano-structures of 200 nm produced by a method as disclosed in the Example 1.

FIG. 3C illustrates a TEM image of the gold rod-shape and branched nano-structures of 100 nm produced by a method as disclosed in the Example 1.

FIG. 3D illustrates a TEM image of the gold rod-shape and branched nano-structures of 120 nm and 130 nm produced by a method as disclosed in the Example 1.

FIG. 4A illustrates a TEM image of the gold rod-shape and branched nano-structures of 110 nm produced by a method as disclosed in the Example 2.

FIG. 4B illustrates a TEM image of the gold rod-shape nano-structures of 200 nm produced by a method as disclosed in the Example 2.

FIG. 4C illustrates a TEM image of the gold rod-shape nano-structures of 170 nm produced by a method as disclosed in the Example 2.

FIG. 4D illustrates a TEM image of the gold rod-shape and branched nano-structures of 130 nm produced by a method as disclosed in the Example 2.

FIG. 5A illustrates a TEM image of the gold rod-shape nano-structures of 100 nm and 40 nm produced by a method as disclosed in the Example 3.

FIG. 5B illustrates a TEM image of the gold rod-shape and branched nano-structures of 100 nm and 20 nm produced by a method as disclosed in the Example 3.

FIG. 5C illustrates a TEM image of the gold rod-shape and branched nano-structures of 170 nm produced by a method as disclosed in the Example 3.

FIG. 6A illustrates a TEM image of the gold rod-shape nano-structures of 130 nm produced by a method as disclosed in the Example 4.

FIG. 6B illustrates a TEM image of the gold rod-shape nano-structures of 170 nm produced by a method as disclosed in the Example 4.

FIG. 6C illustrates a TEM image of the gold rod-shape and branched nano-structures of 100 nm and 20 nm produced by a method as disclosed in the Example 4.

FIG. 7A illustrates a TEM image of the gold rod-shape nano-structures of 100 nm and 50 nm produced by a method as disclosed in the Example 5.

FIG. 7B illustrates a TEM image of the gold rod-shape nano-structures of 100 nm produced by a method as disclosed in the Example 5.

FIG. 7C illustrates a TEM image of the gold rod-shape and branched nano-structures of 135 nm produced by a method as disclosed in the Example 5.

FIG. 7D illustrates a TEM image of the gold rod-shape nano-structures of 100 nm produced by a method as disclosed in the Example 5.

FIG. 7E illustrates a TEM image of a star-shaped gold branched nano-structures of 135 nm produced by a method as disclosed in the Example 5.

FIG. 8A illustrates a TEM image of the gold rod shape nano-structures of 310 nm and 100 nm produced by a method as disclosed in the Example 6.

FIG. 8B illustrates a TEM image of the gold rod shape and branched nano-structures of 200 nm produced by a method as disclosed in the Example 6.

FIG. 8C illustrates a TEM image of a tripod gold branched nano-structures of 80 nm produced by a method as disclosed in the Example 6.

FIG. 8D illustrates a TEM image of the gold rod shape and branched nano-structures of 200 nm produced by a method as disclosed in the Example 6.

FIG. 9A illustrates a TEM image of the gold rod-shape nano-structures of 170 nm produced by a method as disclosed in the Example 7.

FIG. 9B illustrates a TEM image of the gold rod-shape nano-structures of 80 nm produced by a method as disclosed in the Example 7.

FIG. 9C illustrates a TEM image of a double pod gold rod-shape and branched nano-structures of 100 nm produced by a method as disclosed in the Example 7.

FIG. 9D illustrates a TEM image of a double pod gold rod-shape and branched nano-structures of 170 nm produced by a method as disclosed in the Example 7.

FIG. 9E illustrates a TEM image of a star-shaped branched nano-structure of 200 nm produced by a method as disclosed in the Example 7.

FIG. 10A illustrates a UV-NIR spectrum of the gold rod-shape and branched metal nano-structures produced by a reaction performed according to one embodiment.

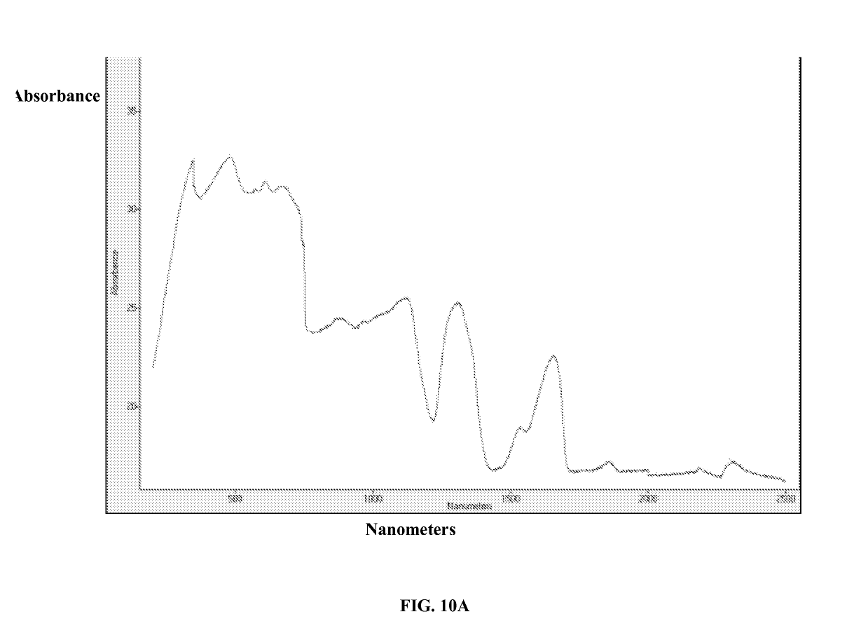

FIG. 10B illustrates a UV-NIR spectrum of the gold rod-shape and branched metal nano-structures produced by a reaction performed according to one embodiment.

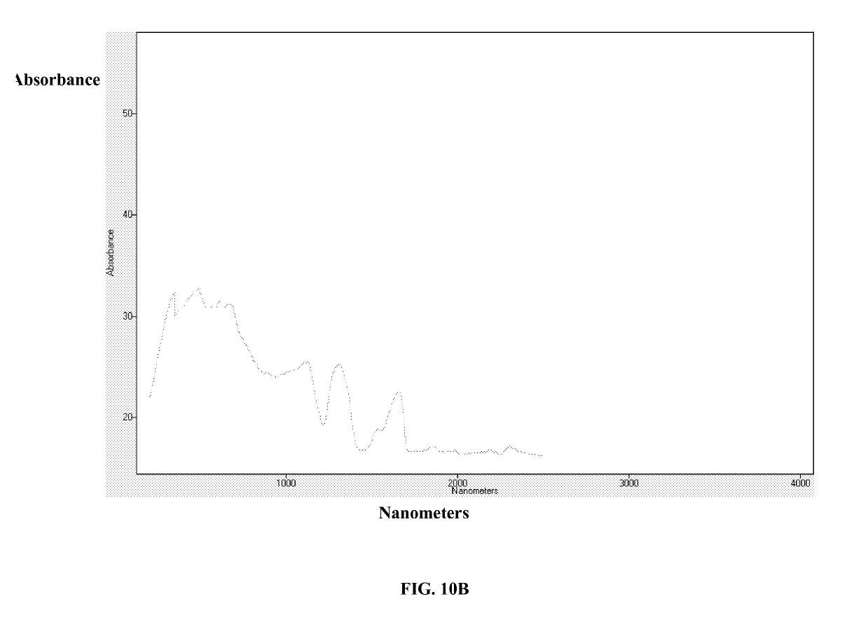

FIG. 10C illustrates a UV-NIR spectrum of the gold rod-shape and branched metal nano-structures produced by a reaction performed according to one embodiment.

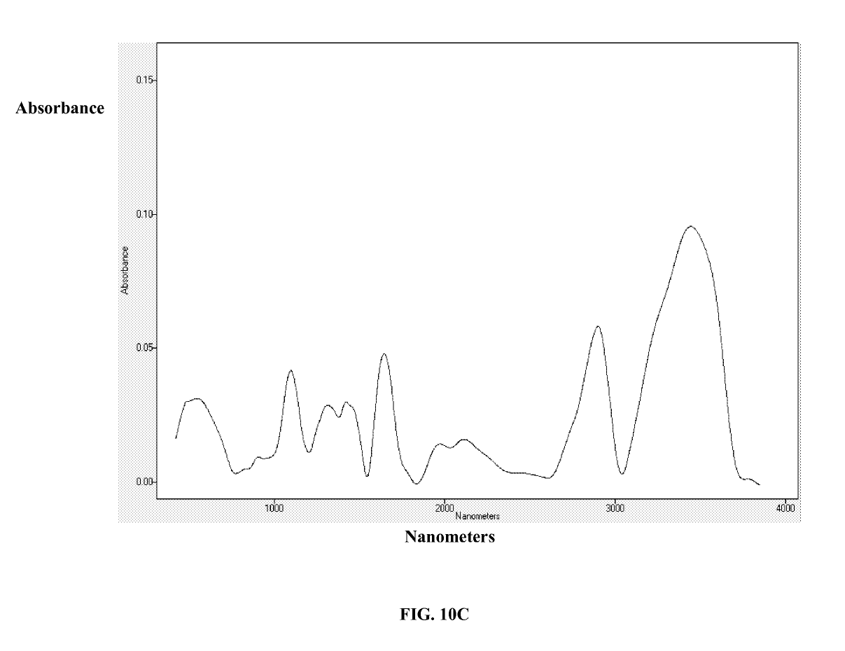

FIG. 10D illustrates a FTIR spectrum of the gold rod-shape and branched metal nano-structures produced by a reaction performed according to one embodiment.

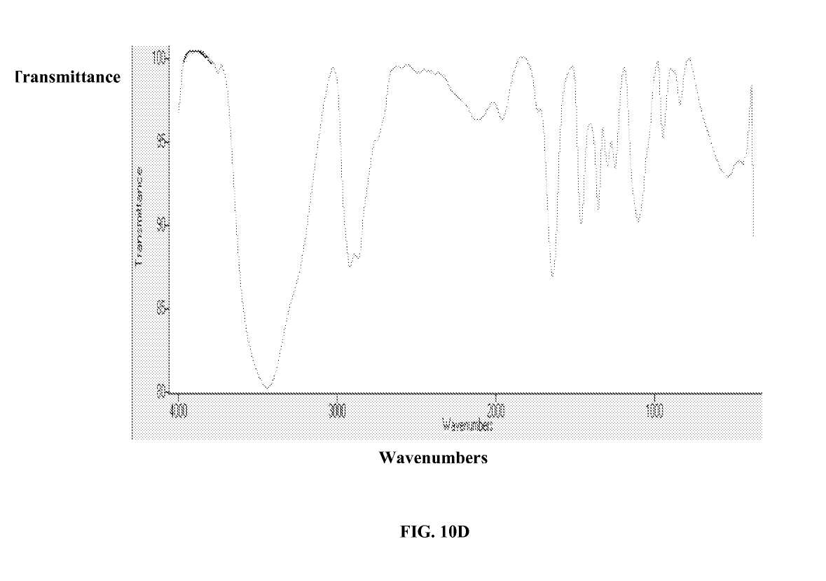

FIG. 10E illustrates a FTIR spectrum of the gold rod-shape and branched metal nano-structures produced by a reaction performed according to one embodiment.

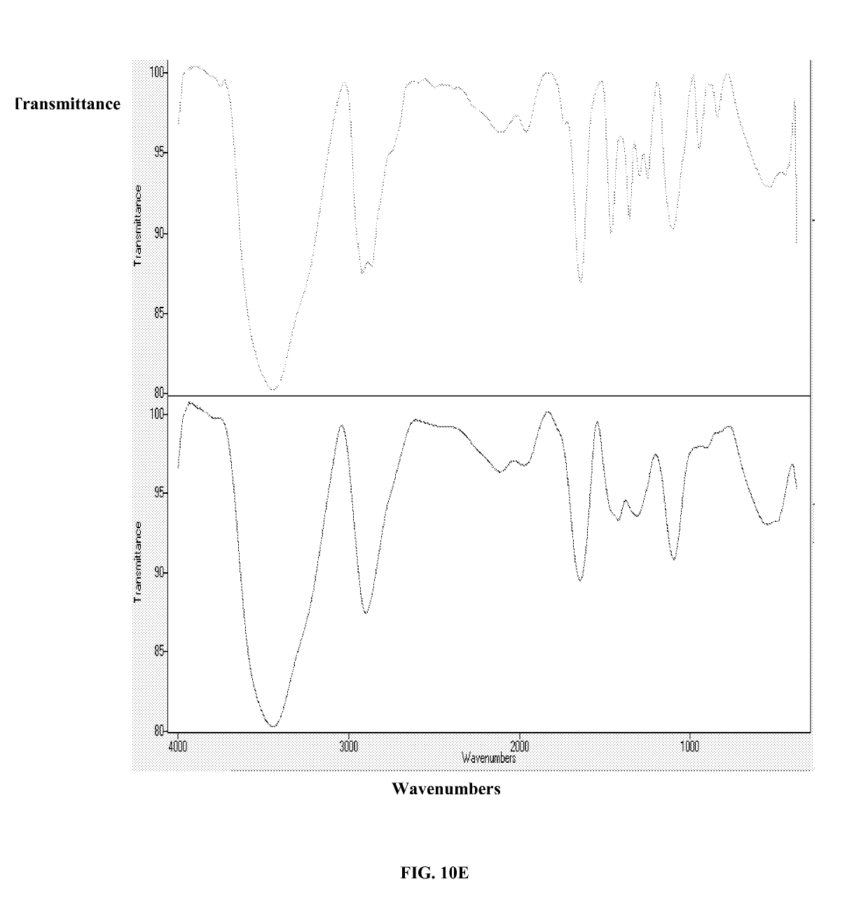

FIG. 11A illustrates an AFM image of the gold rod-shape and branched metal nano-structures by polyol compounds according to one embodiment.

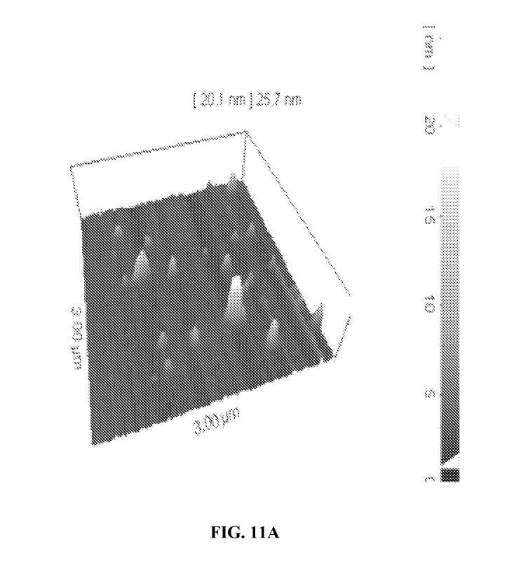

FIG. 11B illustrates an AFM image of the gold rod-shape and branched metal nano-structures by polyol compounds according to one embodiment.

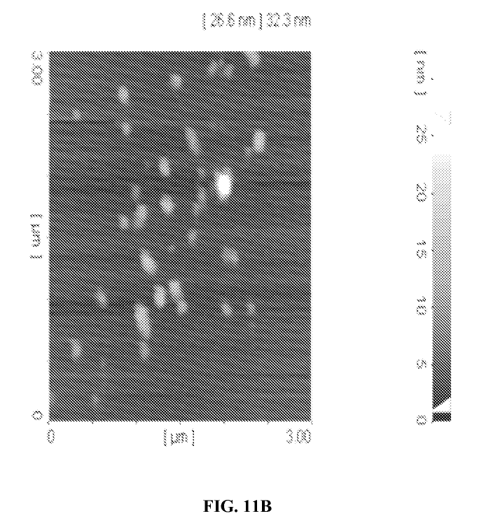

FIG. 11C illustrates an AFM image of the gold rod-shape and branched metal nano-structures by polyol compounds according to one embodiment.

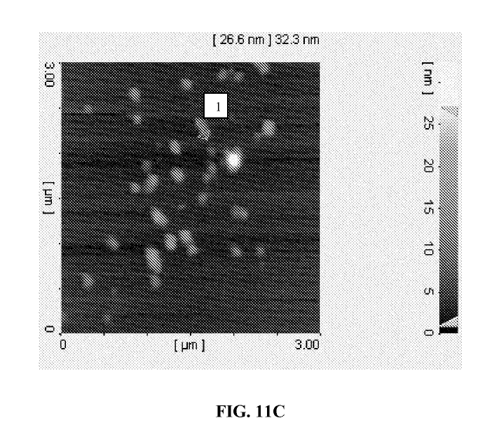

FIG. 11D illustrates an image profile showing the size distribution of the AFM images of the gold rod-shape and branched metal nano-structures by polyol compounds according to one embodiment.

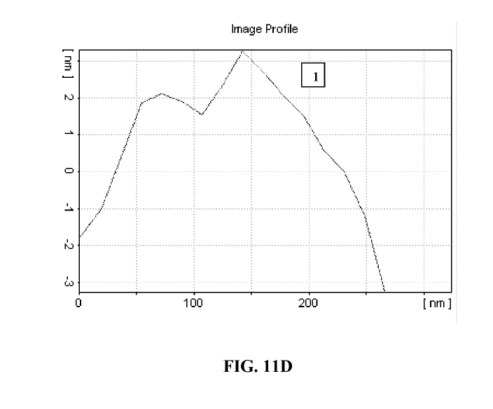

FIG. 12A illustrates AFM image of the gold rod-shape and branched metal nano-structures by polyol compounds according to one embodiment.

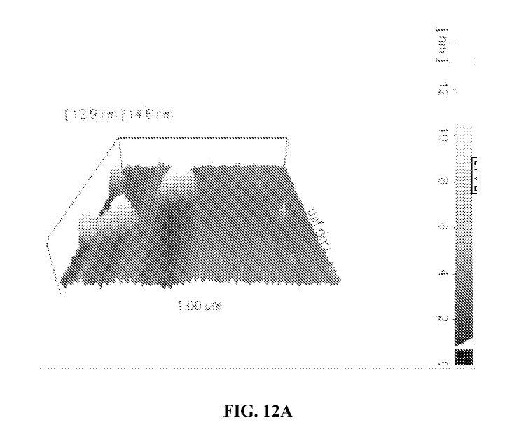

FIG. 12B illustrates AFM image of the gold rod-shape and branched metal nano-structures by polyol compounds according to one embodiment.

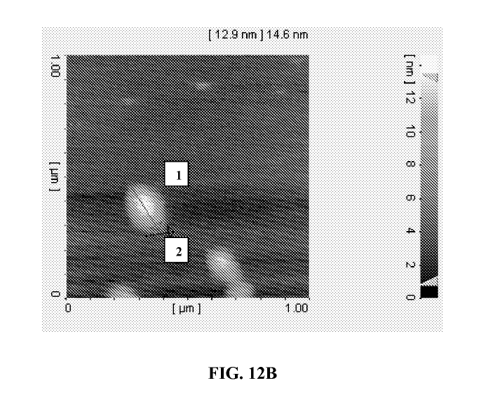

FIG. 12C illustrates an image profile showing the size distribution of the AFM images of the gold rod-shape and branched metal nano-structures by polyol compounds according to one embodiment.

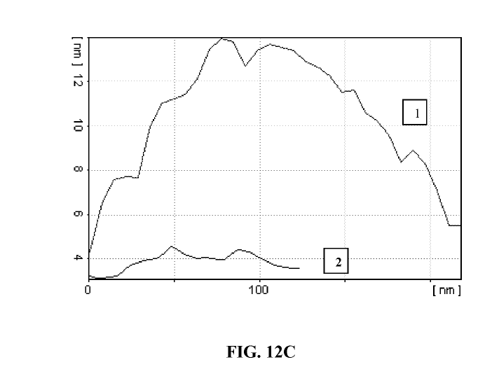

FIG. 12D illustrates AFM image of the gold rod-shape and branched metal nano-structures by polyol compounds according to one embodiment.

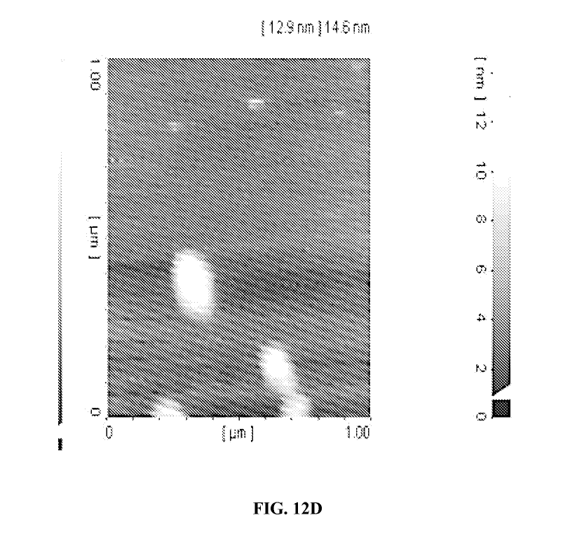

FIG. 12E illustrates AFM image of the gold rod-shape and branched metal nano-structures by polyol compounds according to one embodiment.

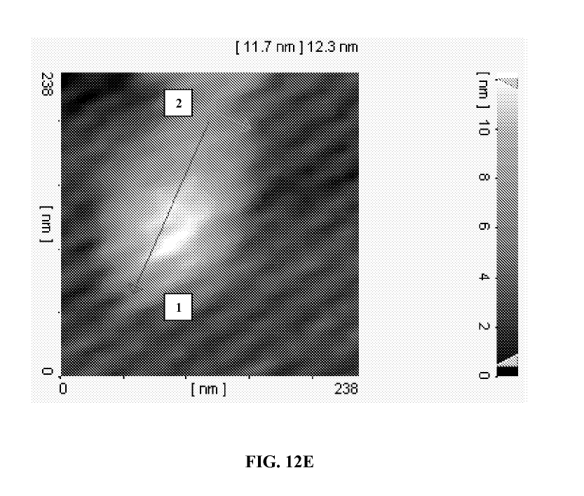

FIG. 12F illustrates an image profile showing the size distribution of the AFM images of the gold rod-shape and branched metal nano-structures by polyol compounds according to one embodiment.

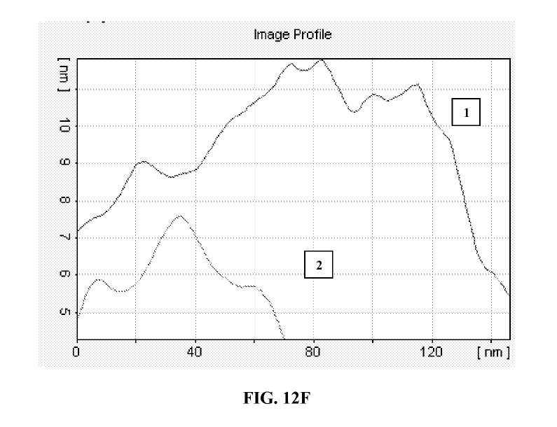

### DETAILED DESCRIPTION OF THE EMBODIMENTS

In the following detailed description, a reference is made to the accompanying drawings that form a part hereof and in which the specific embodiments that may be practiced is shown by way of illustration. The embodiments herein are described in sufficient detail to enable those skilled in the art to practice the embodiments herein and it is to be understood that the logical, mechanical and other changes may be made without departing from the scope of the embodiments herein. The following detailed description is therefore not to be taken in a limiting sense.

The various embodiments herein provide a method of producing rod-shape and branched metal nano-structures. According to one embodiment herein, the method of producing the metal nano-structures comprises reducing chemically a metal salt in a solution using a reducing agent as one step; and irradiating microwave into a solution containing a chemically reduced metal salt at a variable irradiation power and at a designed temperature as another step to obtain a rod-shape and branched metal nano-structure.

According to one embodiment herein, the polyol compound forms an integral component during the method of producing the metal nano-structures as the most preferable reducing agent.

According to one embodiment herein, a method of producing the metal nano-structures is provided. The process involves mixing of a metal salt and a solvent to form a metal salt solution, wherein the metal salt solution is maintained at or below 50° C. or at an ambient temperature. Chemically reducing the metal salt solution by adding a reducing agent, wherein the reducing agent is a polyol compound with a chemical formula HO—CH2-(CH2-O—CH2-) n-CH2-OH—. Radiating the metal salt solution to a preset temperature, wherein the preset temperature is a reaction temperature between 100° C. to about 340° C. under a microwave in a continuous wave mode or in a pulse mode at a preset power of intensity between 600 W-2200 W, wherein a radiation time is 2-30 minutes. Radiating a reducing solvent, wherein the reducing solvent comprises a mixture of polyol compounds under a microwave at a preset temperature, wherein the preset temperature is a reaction temperature of less than or equal to 340° C. in a continuous wave mode or in a pulse mode at a preset power of intensity, wherein a radiation time is 4-8 minutes till the reduction process is complete and a metal nanoparticles are generated. Cooling the metal salt solution containing the metal nano-particles at a room temperature. Precipitating the metal nano-particles by adding a solvent. Washing of the metal nano-particles with the solvent several times. Collecting the metal nano-particle precipitates for analysis. Performing re-precipitation using a methanol or distilled water. Determining the length and diameter of the obtained nano-structures by transmission electron microscopy (TEM).

According to one embodiment herein, the reducing agent is a polyol compound that acts as a stabilizer of the metal nano-structures. The polyol compound accelerates the major axis growth of the metal nano-structures. The polyol compound is selected so as the metal nano-structure precursors are non-volatile at an irradiation temperature.

According to one embodiment herein, the metal salt is selected from a group of compounds of gold, copper, nickel, cobalt, platinum, palladium and their alloys, most preferably selected from a group of gold compounds. The molar concentration of the gold compound is preferably between 0.1M-3.0M.

The metal salt solution further comprises a solvent to dissolve the gold compound to form a gold solution. The solvent may be a single solvent or a mixture of two or more solvents individually or collectively.

The gold solution is maintained at or below 50° C., at or below 40° C., at or below 30° C. or at an ambient temperature. The metal salt solution is reacted on a microwave system at a variable irradiation power for a designed temperature. The irradiation power is maintained 600-2200 W. The reaction temperature is maintained 100° C. to about 340° C. According to another embodiment herein, the reaction temperature is directly proportional to the diameter of the metal nano-structure.

The metal nano-structures have a particular absorption characteristic in a wavelength region from 700 nm to 2,500 nm.

According to one embodiment herein, the configuration of the metal nano-structures is controlled by adjusting the polyol compound; added amount of the surfactant; an amount of the polyol compound; microwave irradiation intensity; and light irradiation time.

According to one embodiment herein, the method of producing the metal nano-structures further comprises tuning a first plasmon-polariton resonance across a first axis of the rod-shape and branched metal nano-structures to a first wavelength and tuning a second plasmon-polariton resonance across a second axis of the rod-shape and branched metal nano-structures to a second wavelength.

The metal nano-structures exhibit multiple resonances spectral range. The metal nano-structures exhibit a spectral resonance positions at microwave or radio frequencies.

According to one embodiment herein, a configuration of metal nano-structures is a metallic nano-rod, a metallic nano-ellipsoid, a metallic nano-wire, a metallic nano-branched and a metallic nano-multi-pod.

According to one embodiment herein, the metal nano-structures produced are used as a coating composition material, a coating, a film, a wiring material, an electrode material, a catalyst, a colorant, a cosmetic, a near-infrared absorber, an anti-counterfeit ink and an electromagnetic shielding material, a surface enhanced fluorescent sensor, a biomarker and a nano-waveguide.

The embodiments herein relates to a method for producing rod-shape and branched metal nano-structures by polyol compounds as reducing agent, the method comprising: a step of chemically reducing a metallic salt in a solution using a reducing agent; and a step of irradiating microwave into the solution in which the metallic salt is chemically reduced so as the mixture solution was reacted on a microwave system that operates in the variable power for designed temperature to generate metal nano-particles in a shape of a rod-shape and branched, referred to as rod-shape and branched metal nano-structures, that excel in optical absorption properties in a region extending from visible light to microwave or radio frequencies. The present invention particularly relates to technology for suppressing a generation of spherical metal nano-particles and technology for controlling a configuration of the producing rod-shape and branched metal nano-structures so as to design its spectral characteristics.

For example, in the case of gold, in the photo-reduction method, an orange-colored (originating from chlorauric acid) solution at a beginning of the reaction becomes clear at first, and then, the color changes to violet, and further changes to blue. Concerning a time period required for the reaction, the period for becoming clear is the longest, and the period from clear to violet is short. If a very slow first photo-reaction process (the process in which the solution becomes clear) which is a rate-determining step for the entire process of producing rod-shape and branched gold nano-structures by the photo-reduction method, can progress in a short time, the time period required for producing rod-shape and branched metal nano-structures can be drastically shortened.

In contrast, when a chemical reducing agent is added to a solution in a same state as that in the photo-reduction method, the color of the solution immediately changes to become clear; however this chemical reduction does not cause a prompt generation of gold nano-particles having plasmon absorption. However, by combining this chemical reduction with the photo-reaction process and substituting the first reduction process in which the reaction is extremely slow in the photo-reduction method, for the chemical reduction, significant acceleration of producing rod-shape and branched gold nano-structures can be realized.

In the embodiments herein, considering the above-mentioned circumstances, a chemical reduction process of a metallic salt solution is employed as a first stage, and a process to irradiate microwave into the chemically reduced metallic salt solution is employed as a second stage.

According to one embodiment herein, employing both of the chemical reduction process and irradiating microwave process, it is possible to produce the rod-shape and branched metal nano-structures in a short time.

In addition, the time period for the microwave irradiation into the metal salt solution containing the reducing agent is shortened. Thereby, it is possible to manufacture produce the rod-shape and branched gold nano-structures having target wavelength absorption characteristics efficiently.

According to one embodiment herein, a method for producing rod-shape and branched metal nano-structures by polyol compounds as reducing agent including the following features can be provided.

A method for producing rod-shape and branched metal nano-structures by polyol compounds includes: a step of chemically reducing a metallic salt in a solution using a reducing agent as the mixture solution; and a step of irradiating microwave into the solution in which the metallic salt is chemically reduced so as the mixture solution was reacted on a microwave system that operates in the variable power for designed temperature to generate metal nano-particles in a shape of a rod-shape and branched, referred to as rod-shape and branched metal nano-structures.

A method for producing rod-shape and branched metal nano-structures by polyol compounds as reducing agent, the method comprising: a step of chemically reducing a metallic salt in a solution using a reducing agent; and a step of irradiating microwave into the solution in which the metallic salt is chemically reduced so as the mixture solution was reacted on a microwave system that operates in the variable power for designed temperature to generate metal nano-particles in a shape of a rod-shape and branched, referred to as rod-shape and branched metal nano-structures, wherein a metallic salt solution containing polyol compounds such as polyethylene oxide compounds as the reducing agent are used and microwave is radiated into the metallic salt solution.

According to one embodiment herein, a method for producing rod-shape and branched metal nano-structures, wherein at least one of type polyol compounds such as polyethylene oxide is used as the reducing agent.

A method for producing rod-shape and branched metal nano-structures, wherein microwave is radiated into the metallic salt solution in a presence of a substance which accelerates a major axis growth of the rod-shape and branched metal nano-structures. A method for producing rod-shape and branched metal nano-structures, wherein a configuration of the gold nano-structure is controlled by adjusting at least any one of types of polyol compounds such as polyethylene oxide, added amount of the surfactant, added amount of the substance which accelerates the major axis growth of the rod-shape and branched metal nano-structures, microwave irradiation intensity and light irradiation time. A method for producing rod-shape and branched metal nano-structures according to any one of the above, wherein in the step of radiating light, microwave system that operates in the power of 600-2200 W for designed temperature. The producing method according to any one of the above, wherein the rod-shape and branched metal nano-structures are metals selected from the group consisting of gold, gold, copper, nickel, cobalt, platinum, palladium and their alloys.

Also, according to one embodiment herein, the following usages which include rod-shape and branched metal nano-structures produced using the method of the present invention can be provided.

According to one embodiment herein, the method of producing of the metal nano-structures according to the present invention, the rod-shape and branched metal nano-structures can be produced quickly and easily.

The great advantage of this invention is that templates are not necessary and the crystallization time is short. Furthermore, in the manufacturing method of the present invention, a ratio of a generation of spherical metal nano-particles which are by-products is small.

Therefore, fractionation and purification after reaction are not required. In addition, configuration control of the metal nano-structures is easy; therefore, metal nano-structures of which spectral characteristics are controlled in a wide wavelength region from the visible light to the microwave or radio frequencies rays can be obtained.

The adjustment of the rod length enables setting of the absorption band in the Infrared region from the vicinity of 700 nm to radio frequencies region the vicinity of 2,500 nm.

The tunable NIR absorbance of gold in conjunction with its low cytotoxicity has fueled research in the synthesis of rod-like gold nano-crystals for a wide range of biomedical applications such as sensing, imaging, and photothermal therapy. However, a fundamental problem in the realization of these technologies is the need for (cytotoxic) surfactants—such as cetyltrimethylammonium bromide (CTAB)—in order to induce the anisotropic particle growth in aqueous solution. Herein we present an alternate synthetic strategy based polyol compound that alleviates the need for shape-regulating.

As used herein, ‘aspect ratio’ should be interpreted differently depending on whether it is being used with reference to an individual nanostructure or to the general characteristics of bulk material.

With respect to an individual nanostructure, ‘aspect ratio’, as used herein, refers to the length divided by diameter of the individual nanostructure.

According to the embodiments herein, with respect to practice of the methods, the terms ‘added’, ‘mixed’ or ‘combined’ are generally interchangeable and refer to the act of adding, mixing or combining one or more of the reactants with one or more other reactants. This can occur by adding reactants to, or mixing or combining the reactants in, the reaction vessel and/or with each other.

According to the embodiments herein, ‘halide ion’ refers to fluoride ion, chloride ion, bromide ion or iodide ion.

According to the embodiments herein, ‘nano-rods’ refers to nanostructures having an elongated shape wherein the length and diameter dimension produce aspect ratios of between 2 and less than 10.

According to the embodiments herein, ‘reaction temperature’ refers to the temperature of the heat source applied to the reaction vessel or the actual temperature of the reaction mixture during the reaction as determined by direct monitoring. For example, the reaction temperature can be the temperature of an oil bath used to heat the vessel containing all the reactants of a polyol reaction or could be the temperature of the reaction mixture as determined by a thermometer or thermocouple inserted into said reaction mixture.

According to the embodiments herein, ‘reaction mixture’ refers to both the mixture of reactants as fully combined as well as to a mixture to which one or more of the reactants is being added but to which at least a portion of all the reactants has been added such that the reaction can begin. For example, in the polyol process, it is common to add drop wise the gold solution and a solution comprising the organic protective agent into a vessel comprising polyol. From the time the first drops of gold solution and solution comprising the protective agent mix with the polyol in the vessel, the reaction has begun despite the fact that not all of each of the reactants has yet been combined. Thus, according to this definition, the vessel comprising the drops of gold solution, solution comprising the protective agent and the polyol is a reaction mixture.

### Polyol(s)

The polyol is selected to be capable of reducing the gold compound to gold metal at the reaction temperature when present in the reaction mixture. The polyol can also be selected for its ability to dissolve the gold compound to thereby produce the gold solution that is often combined according to the polyol process. The polyol can also be selected based upon its ability to influence the formation of gold rod-shape and branched metalic nanostructures over other gold nanostructures under the reaction conditions. The polyol can also be selected for its ability to dissolve the organic protective agent as described infra. The foregoing criteria are not mutually exclusive such that, the polyol is typically selected based on a consideration of all of the foregoing criteria.

The polyol may be a single polyol or a mixture of two or more polyols (e.g. three, four, five or more polyols). Whenever the term “polyol” is used herein, this term is meant to include both a single polyol and a mixture of two or more polyols unless used as part of the phrase “polyol or polyols” or “polyol(s)” (both of which include the singular and plural version of this term) or where use of the singular term is clearly intended or required.

The polyol may have any number of hydroxyl groups (but at least two) and carbon atoms provided that it comprises 2 or more hydroxyl groups. Also, the polyol may comprise heteroatom (such as, e.g., O and N); not only in the form of hydroxyl groups, but also in the form of, e.g., ether, ester, amine and/or amide groups and the like (for example, the polyol may be a polyester polyol, a polyether polyol, etc.). A polyol can be either an aliphatic glycol or corresponding glycol polyester. Said aliphatic glycol, for instance, can be an alkylene glycol having up to 6 carbon atoms in the main chain. Examples include ethanediol, a propanediol, a butanediol, a pentanediol or a hexanediol, as well as polyalkylene glycols derived from these alkylene glycols.

In one embodiment herein, the polyol comprises from about 2 to about 6 hydroxy groups (e.g., 2, 3 or 4 hydroxy groups) and from 2 to about 12 carbon atoms (e.g., 3, 4, 5 or 6 carbon atoms). The (alkylene) polyol can be a glycol, i.e., compounds which comprise two hydroxyl groups bound to adjacent (aliphatic or cycloaliphatic) carbon atoms. For example, the glycols can comprise up to about 6 carbon atoms, e.g., 2, 3 or 4 carbon atoms. Some useful polyols include glycerol, trimethylolpropane, pentaerythritol, triethanolamine and trihydroxymethylaminomethane.

In one embodiment herein, a polyol can be ethylene glycol, diethylene glycol, tri-ethylene glycol, a propylene glycol, a butanediol, a dipropylene glycol or a polyethylene glycol that is liquid at the reaction temperature, such as for example, polyethylene glycol 300. Other useful polyols include tetra-ethylene glycol, propanediol-1,2, di-propylene glycol, butanediol-1,2, butanediol-1,3, butanediol-1,4 and butanediol-2,3. The use of these glycols is advantageous because of their significant reducing power, their boiling temperature of between 185.degree. C. and 328.degree. C., their proper thermal stability and their low cost price. Furthermore, these glycols raise few toxicity problems.

Another non-limiting grouping of polyols suitable for use in the process of the present invention includes: ethylene glycol, glycerol, glucose, diethylene glycol, tri-ethylene glycol, a propylene glycol, a butanediol, a dipropylene glycol and/or a polyethylene glycol.

It also is possible to use other polyols than those mentioned above, either alone or in combination. For example, sugars and sugar alcohols can form at least a part of the polyol reactant.

Polyols that are solid or semi-solid at room temperature may be employed; the employed polyol or at least the employed mixture of polyols will generally be liquid at room temperature and at the reaction temperature, although this is not mandatory.

According to the embodiments herein, the polyol and the associated reaction conditions are selected to preferentially produce gold rod-shape and branched metal nanostructures as compared with other nanostructures. Thus, using no more than the guidance provided herein and routine experimentation, one of skill in the art will be able to select polyols that can be used (according to the presently disclosed inventive methods) to selectively produce gold rod-shape and branched metal nanostructures.

From an economic and environmental standpoint, it is interesting to note that the polyols can often be re-used. For example, the polyols can usually be recaptured and used again in other reactions or else they can be purified by distillation or crystallization prior to reuse.

### Gold Compound

The gold compound is a source of the gold metal that produces the gold nanostructures according to the polyol method. In general, the gold compound can be any gold compound that produces gold metal when reduced. If the gold compound is to be used dissolved in a solution, it should be at least partially soluble in the gold solvent and/or polyol. Complete solubility is not required because suspensions can be used. Whether used in solution, as a suspension or in solid form any counter ion (e.g. anion) should not interfere with the reduction reaction.

According to the polyol method, the gold compound is reduced by the polyol (and/or by supplemental reducing agents) to thereby produce silver metal in-situ. The gold metal that is formed, depending on the reaction conditions employed (See: Wiley et al., Maneuvering the Surface Plasmon Resonance of silver Nanostructures through Shape-Controlled Synthesis, J. Phys. Chem. B., 110: 15666-15675 (2006)), produces various types of silver nanostructures.

According to the embodiments herein, the gold compound, other reactants and the associated reaction conditions are selected to preferentially produce gold rod-shape and branched metal nanostructures as compared with other nano structures.

According to one embodiment herein, the gold compound can be a gold oxide, a gold hydroxide or a gold salt (organic or inorganic). Non-limiting examples of suitable gold compounds include gold salts of inorganic and organic acids such as, e.g., nitrates, nitrites, sulfates, halides (e.g., fluorides, chlorides, bromides and iodides), carbonates, phosphates, azides, borates (including fluoroborates, pyrazolylborates, etc.), sulfonates, carboxylates (such as, e.g., formates, acetates, propionates, oxalates and citrates), substituted carboxylates (including halogenocarboxylates such as, e.g., trifluoroacetates, hydroxycarboxylates, aminocarboxylates, etc.) and salts and acids wherein the gold is part of an anion (such as, e.g., hexachloroplatinates, tetrachloroaurate, tungstates and the corresponding acids) as well as combinations of any two or more of the foregoing.

Further non-limiting examples of suitable gold compounds for the process of the embodiments herein include alkoxides, complex compounds (e.g., complex salts) of gold such as, e.g., beta-diketonates (e.g., acetylacetonates), complexes with amines, N-heterocyclic compounds (e.g., pyrrole, aziridine, indole, piperidine, morpholine, pyridine, imidazole, piperazine, triazoles, and substituted derivatives thereof), aminoalcohols (e.g., ethanolamine, etc.), amino acids (e.g., glycine, etc.), amides (e.g., formamides, acetamides, etc.), and nitriles (e.g., acetonitrile, etc.) as well as combinations of any two or more of the foregoing.

In some embodiments, the gold compound is selected such that the reduction by-product is volatile and/or can be decomposed into a volatile by-product at a relatively low temperature.

In one embodiment herein, the solvent used to dissolve the gold compound to thereby form the gold solution may be a single solvent or a mixture of two or more solvents (individually or collectively (as appropriate) referred to herein as ‘gold solvent’). For example, in some embodiments, the gold solvent is the polyol (i.e. a single polyol or a mixture of polyols).

In the embodiments herein, the gold solvent is a mixture of the polyol and one or more other solvents that, for example, may be selected because the gold compound is more soluble in this solvent or these solvents.

In the embodiments herein, the gold solvent does not comprise the polyol but rather comprises one or more other solvents that, for example, may be selected because the gold compound is more soluble in the selected solvent or solvents than it is in the polyol.

In one embodiment herein, the concentration of the gold compound in gold solution is in the range of about 0.1 M to about 3.0 M.

In the embodiments herein, the molar concentration of the gold compound in gold solution is in the range of about 0.25 M to about 2.5 M. In some embodiments, the molar concentration of the gold compound in gold solution is in the range of about 0.3 M to about 3.0 M. In some embodiments, the molar concentration of the gold compound in gold solution is in the range of about 0.5 M to about 3.0 M. In some embodiments, the molar concentration of the gold compound in gold solution is in the range of about 0.5 Mm to about 5.0 M. In some embodiments, the molar concentration of the gold compound in gold solution is in the range of about 0.1 M to about 5.0 M. In some embodiments, the molar concentration of the gold compound in gold solution is in the range of about 1.0 M to about 3.0 M.

In one embodiment herein, solvents, other than the polyol, that may be used to produce the gold solution include protic and aprotic polar solvents that are non-oxidative.

Non-limiting examples of such solvents include aliphatic, cycloaliphatic and aromatic alcohols (the term “alcohol” as used herein is used interchangeably with the terms “monoalcohol” and “monohydric alcohol”) such as, e.g., ethanol, propanol, butanol, pentanol, cyclopentanol, hexanol, cyclohexanol, octanol, decanol, isodecanol, undecanol, dodecanol, benzyl alcohol, butyl carbitol and the terpineols, ether alcohols such as, e.g., the monoalkyl ethers of diols such as, e.g., the C.sub.1-6 monoalkyl ethers of C.sub.1-6 alkanediols and polyetherdiols derived therefrom (e.g., the monomethyl, monoethyl, monopropyl and monobutyl ethers of ethylene glycol, diethylene glycol, triethylene glycol, propylene glycol, dipropylene glycol, 1,3-propanediol, and 1,4-butanediol such as, e.g., 2-methoxyethanol, 2-ethoxyethanol, 2-propoxyethanol and 2-butoxyethanol), aminoalcohols such as, e.g., ethanolamine, amides such as, e.g., dimethylformamide, dimethylacetamide 2-pyrrolidone and N-methylpyrrolidone, esters such as, e.g., ethyl acetate and ethyl formate, sulfoxides such as, e.g., dimethylsulfoxide, ethers such as, e.g., tetrahydrofuran and tetrahydropyran, and water.

### Temperature of the Gold Solution

The temperature of the gold solution may, at least in part, depend on the nature of the gold solvent. In addition to the potential for prematurely reducing the gold compound to gold metal, other factors should be considered when determining the temperature of the gold solution. For example, too low a temperature may increase the viscosity of the solution and/or reduce the solubility of the gold compound to an undesirable degree.

Too low a temperature may also significantly lower the reaction temperature or the temperature of other reactants when the gold solution is combined with the other reactants.

Thus, the ordinary practitioner will appreciate that the temperature of the gold solution during storage and at the time when it is combined with the other reactants can be selected to influence the product of the polyol reaction.

If the gold solvent is a polyol or comprises a polyol, the gold solution can be maintained at or below 50° C.; at or below 40° C., at or below 30° C. or at ambient temperature. A temperature above 50° C. is not prohibited but it should be kept in mind that a lower temperature reduces the reaction rate of the reductive conversion of the gold compound to gold metal.

The length of time the gold solution is to be stored before it is used is also a consideration. If the gold solution need be stored before it is used, it can be kept cool (even below ambient temperature) under conditions that prevent (or minimize) the gold compounds' reduction and then warmed to the appropriate temperature before use.

If the gold solvent does not comprise a polyol and does not contain a reducing agent or reducing agents, the temperature of the gold solution can be elevated above ambient temperature increasing the solubility of the gold compound and/or to avoid a large drop in reaction temperature when the gold solution is combined with the other reactants.

If the solvent does contain a polyol, then for a very short time, the temperature of the gold solvent may be elevated. Thus, in some embodiments, the temperature of the gold solution can be about room temperature.

In the embodiments herein, the temperature of the gold solution can be higher than ambient temperature or even significantly above ambient temperature. In the embodiments herein, the gold solution can be heated to the intended reaction temperature, or above this temperature, so that combining the gold solution with one or more of the other reactants does not result in a substantial decrease in the reaction temperature of the reaction mixture.

For example, in the embodiments herein, the temperature of the gold solution can be 100° C. or above, can be 110° C. or above, can be 120° C. or above, can be 130° C. or above or can be 140° C. or above about 180° C. to about 190° C., about 190° C. to about 200° C., about 200° C. to about 220° C., about 220° C. to about 240° C. or about 240° C. to about 260° C. or about 260° C. to about 280° C. to about 300° C. to about320° C. to about 340° C.

Accordingly, in the embodiments herein, those of skill in the art, using no more than knowledge available to the ordinary practitioner, the disclosure provided herein and routine experimentation, can select an appropriate temperature for the gold solution to preferentially produce gold rod-shape and branched metal nanostructures as compared with other nanostructures.

### Reaction Temperature

The ‘reaction temperature’ is the temperature of the mixture once at least a portion of the polyol, the gold compound (or gold solution).

Surprisingly, it is observed the polyol reaction is operated at a reaction temperature significantly below 160° C. and can still produce product solutions comprising a greater weight percent of rod-shape and branched metal nanostructures as compared with the weight percent of all other nanostructures. For example, the reaction temperature can be less than or equal to 340° C.

### Reaction Time

The reaction time is measured from the time that at least a portion of each of the reactants to be reacted are combined (i.e. there must be a mixture that contains at least a portion of each of the reactants that are to be reacted) and then extends through any time where a continued combining of the reactants occurs until the time when all reactants have been added to the reaction.

The reaction time also includes the time after all of the reactants have been combined during which nanostructures are produced. The reaction time also includes the time after nanostructures are produced, the reaction is cooled, and until the process of separating the metal from the other components of the product solution (e.g. by decanting, filtration, precipitation, or centrifugation) is completed.

There is no limitation on the reaction time. It can be as short as 1-2 minutes (or shorter) or as long as a week (or longer). In general the reaction is complete when the gold metal has formed nanostructures. Although in some cases the reaction can be permitted to continue so that processes, such as Ostwald Ripening (See: Goldt et al., Preparation of colloidal gold dispersions by the polyol process, Part 2—Mechanism of particle formation; J. Mater. Chem. 7(2): 293-299 (1997) at the abstract and FIG. 14), can occur, this is not essential.

Thus, in the embodiments herein, using no more than the disclosure provided herein and routine experimentation, one of skill in the art can select an appropriate reaction time to preferentially produce gold rod-shape and branched metal nanostructures as compared with other nanostructures.

### BEST MODE FOR CARRYING OUT THE EMBODIMENTS

The manufacturing method of the embodiments herein is specifically described hereafter by referring to an embodiment of manufacturing gold nano-rods. Here, methods for manufacturing other metal, such as gold nano-rods, are basically similar, as shown in the below-mentioned embodiments.

In order to synthesize gold nano-rods using the manufacturing method of the embodiments herein, a solution containing soluble gold salt is used as a synthesis solution. Specifically, for example, a solution containing a gold complex compound, which can be easily handled, is preferable, and a gold halide solution or a gold cyanide solution, which is easily prepared, is more preferable. For a gold salt concentration in the synthesis solution, a range of 0.1 M to 5.0M is appropriate, and a range of 1.0 M to 3.0M is more preferable.

Light irradiation intensity, light irradiation time and irradiation wavelength can also determine the generation and the configuration of the gold nano-rods. For the light to be radiated, microwave rays having a wavelength of less than 315 nm, preferably microwave rays having a wavelength of 310 nm or less are effective. The radiation time was between 2-30 minutes.

Metal nano-rods manufactured by the above-mentioned method of the embodiments herein are suitable for materials for a coating composition, a coating, a film, a wiring material, an electrode material, a catalyst, a colorant, a cosmetic, a near-infrared absorber, an anti-counterfeit ink and an electromagnetic shielding material. In addition, the metal nano-rods of the present invention can be used for materials for a surface enhanced fluorescent sensor, a biomarker and a nano-waveguide.

In addition, the metal nano-rods of the embodiments herein can be used as a biomarker responding to near infrared rays. For example, near infrared rays with 750 nm to 1,100 nm wavelength and infrared rays, radio-frequency rays with 1000 nm to 2500 nm wavelength are not substantially absorbed by organic substances. However, the gold nano-rods can have a particular absorption characteristic in the wavelength region from 750 nm to 2,500 nm depending on the aspect ratio. Therefore, in the case in which a particular site of a living body is stained with the gold nano-rods, when the near infrared rays are radiated, the near infrared rays are absorbed ay that site, thereby the site can be identified. Therefore, with regard to a thick biomaterial which cannot be measured by a conventional method involving a suspension or a coloration of the biomaterial, it becomes possible to observe an optional portion colored by the gold nano-rods.

Rod-shaped gold nanoparticles (‘nano-rods’) have recently attracted widespread attention due to their unique optical properties and facile synthesis. In particular, they can support a longitudinal surface plasmon, which results in suspensions of them having a strong extinction peak in the upper visible or near-infrared parts of the spectrum. The position of this peak can be readily tuned by controlling the shape of the rods. In addition, the surface of the nano-rods can be functionalized by a very wide variety of molecules. This has led to interest in their use as selective biomarkers in bio-diagnostics or for selective targeting in photo-thermal therapeutics.

Cancer cells are relatively temperature-sensitive. This is exploited in treatments involving overheating of parts of the cancer patient's body. One highly promising method is photo-induced hyperthermia, in which light energy is converted to heat. Gold nanoparticles absorb light very strongly in the near infrared, a spectral region that is barely absorbed by tissue. The absorbed light energy causes the gold particles to vibrate and is dissipated into the surrounding area as heat. The tiny gold particles can be functionalized so that the specifically bind to tumor cells. Thus, only cells that contain gold particles are killed off.

Interest in gold nano-rods, in particular, has recently soared, both because their optical properties are well-matched for exploitation in diagnostic and therapeutic applications, and because of significant improvements to the wet chemical process by which they can be produced (Jana et al., 2001; Perez-Juste et al., 2004). Background information on gold nano-rods is available in some excellent reviews (Murphy et al., 2005; Perez-Juste et al., 2005); here we will provide only the information essential to appreciate the possible role of these particles in biotechnological applications.

The rod-shape shape of these gold nanoparticles causes them to have strong surface plasmon absorption and, if they are big enough, an enhanced capability to scatter light. The first attribute is useful in the development of a selective therapeutic agent and the second for imaging and diagnostics. Actually, gold nano-rods have two surface plasmon resonance modes: transverse and longitudinal. The transverse surface plasmon resonance, which is due to an electronic oscillation across the width of the rod, is effectively of the same nature as the plasmon resonance of simple gold nano-spheres. It peaks at about ˜520 nm (i.e. at the wavelength of green light) and is comparatively weak. However, the longitudinal mode provides a much larger extinction coefficient and is due to oscillation of electrons in the long direction of the rod. It occurs at longer wavelengths than the transverse resonance (i.e. it is ‘red-shifted’ relative to the transverse mode) (Kelly et al., 2003). When compared with other shapes of gold nanoparticles such as nano-shells and nano-spheres, gold nano-rods also provide superior competence of light absorption at their longitudinal plasmon resonance (Harris et al., 2008; Jain et al).

### Experimental Data

### EXAMPLE 1

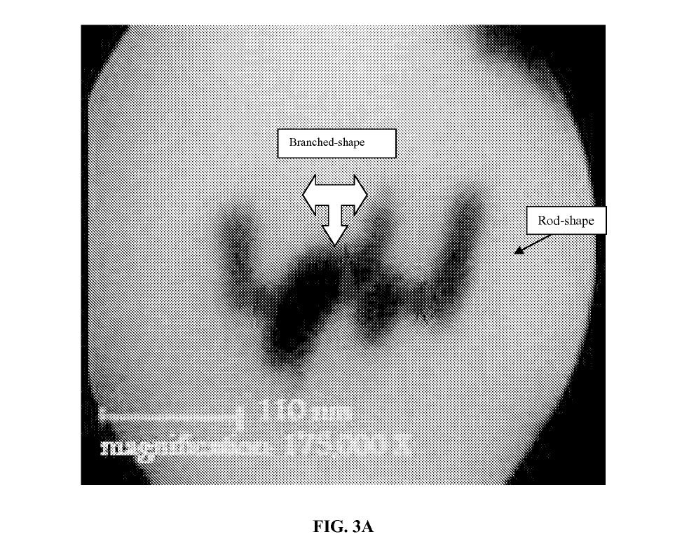

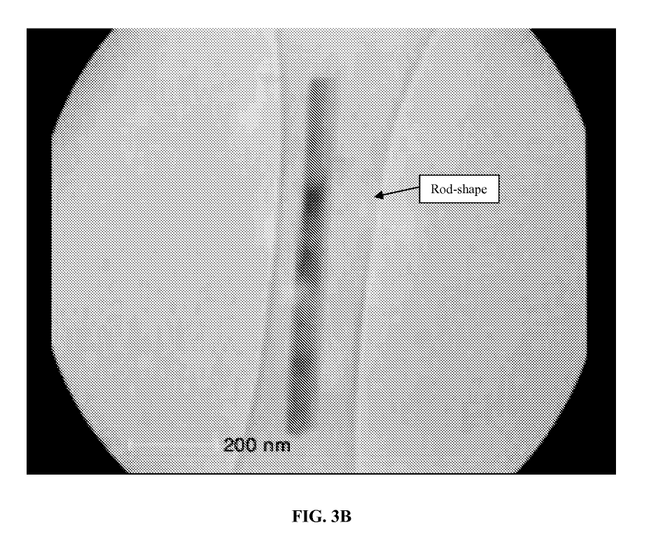

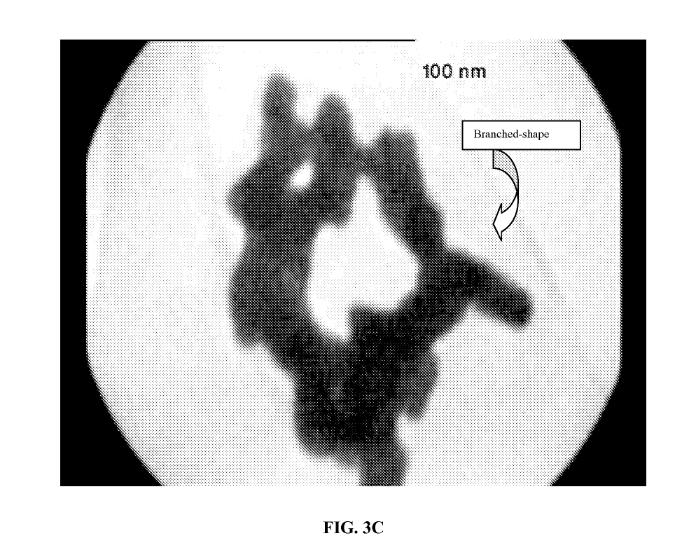

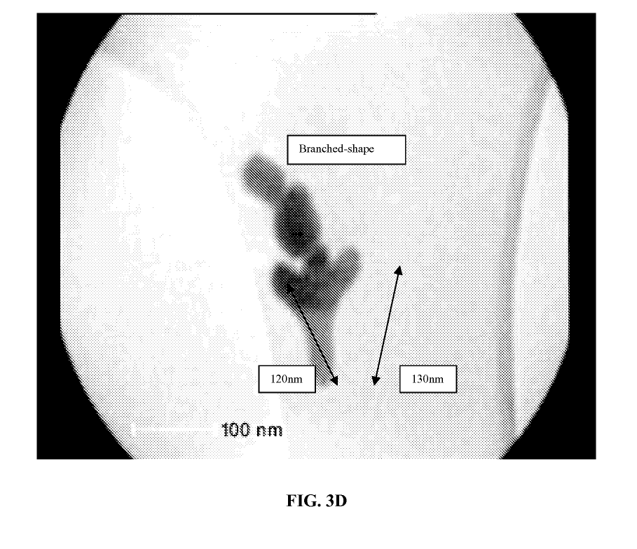

10 ml of 5M HAuCl4.3H2O was mixed with 500 ethylene glycol and polyethylene glycol 1000 to form a mixture solution. The mixture solution was heated to 250° C. under microwave (MW) in a continuous wave (CW) or pulse mode 100% power of 600 W for 2-10 min. Subsequently, the reducing solvent comprising the mixture of polyethylene glycol 6000 and propylene glycol 300 was heated to 200° C. under microwave (MW) in a continuous wave (CW) or pulse mode 100% power of 600 W for 4 min. The mixture was held at 200° C. for 5 min until the reduction was complete (visually, the color of the solution was changed to blue). After the reaction, the solution containing gold nanoparticles was cooled to room temperature. Ethanol was then added to precipitate gold nanoparticles. After washing several times with ethanol, the precipitated gold nanoparticles were collected for analysis. After 2 hours of the reaction, re-precipitation was performed using methanol or DI water. The nanostructures length and diameter was determined by transmission electron microscopy (TEM) (FIGS. 3A-3D).

### EXAMPLE 2

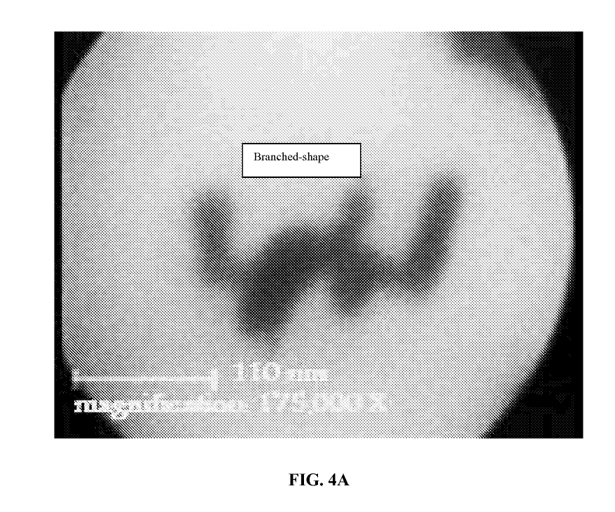

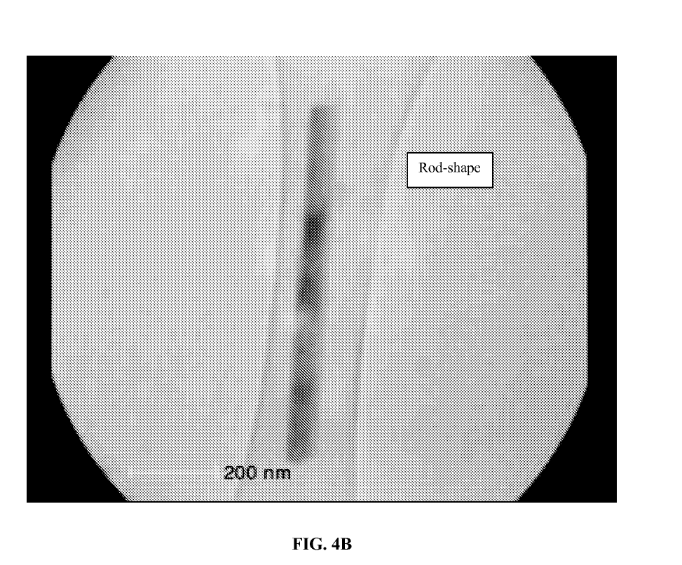

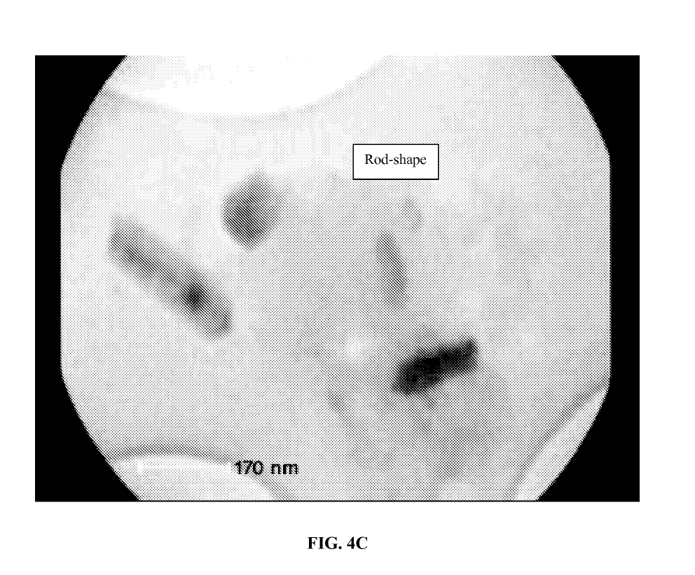

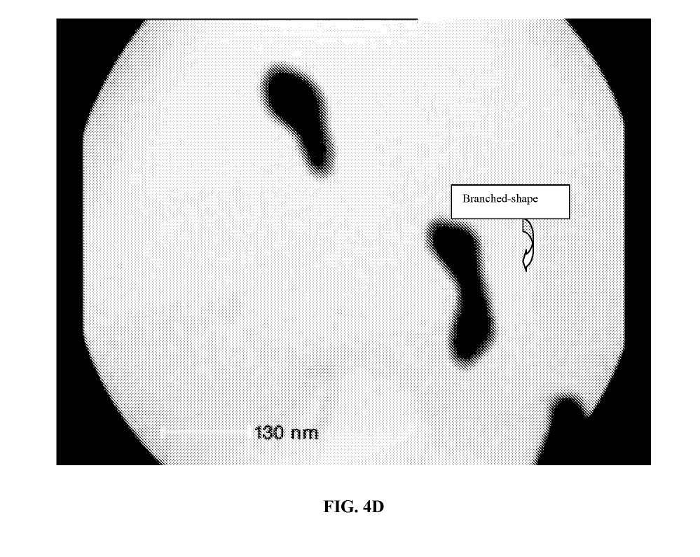

10 ml of 3.5 mM HAuCl4.3H2O was mixed with 500 ml polyethylene glycol 6000 and 500 ml polyethylene glycol 2000 to form a mixture solution. The mixture solution was heated to 250° C. under microwave (MW) in a continuous wave (CW) or pulse mode 100% power of 1000 W for 2-10 min. Subsequently, the reducing solvent comprising the mixture of 500 ml PEG 1000 and 200 ml propylene glycol 300 was heated to 200° C. under microwave (MW) in a continuous wave (CW) or pulse mode 100% power of 600 W for 4 min. (visually, the color of the solution was changed to blue). After the reaction, the solution containing gold nanoparticles was cooled to room temperature. Ethanol was then added to precipitate gold nanoparticles. After washing several times with ethanol, the precipitated gold nanoparticles were collected for analysis. After 2 hours of the reaction, re-precipitation was performed using methanol or DI water. The nanostructures length and diameter was determined by transmission electron microscopy (TEM) (FIGS. 4A-4D).

### EXAMPLE 3

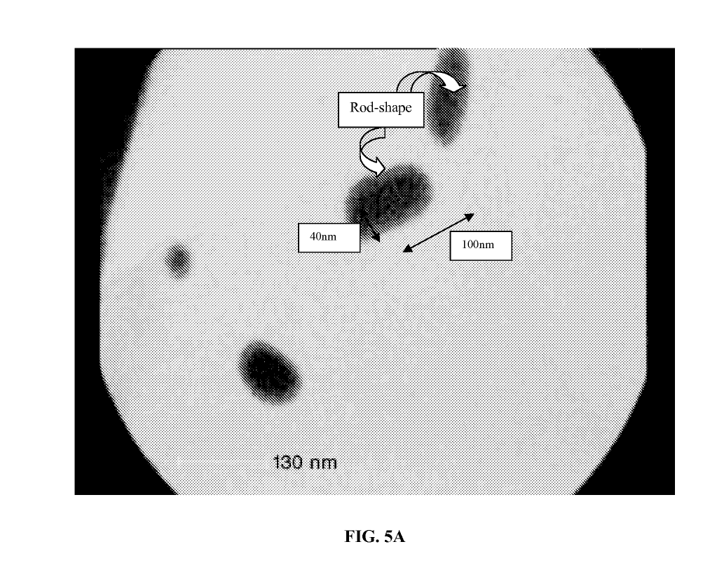

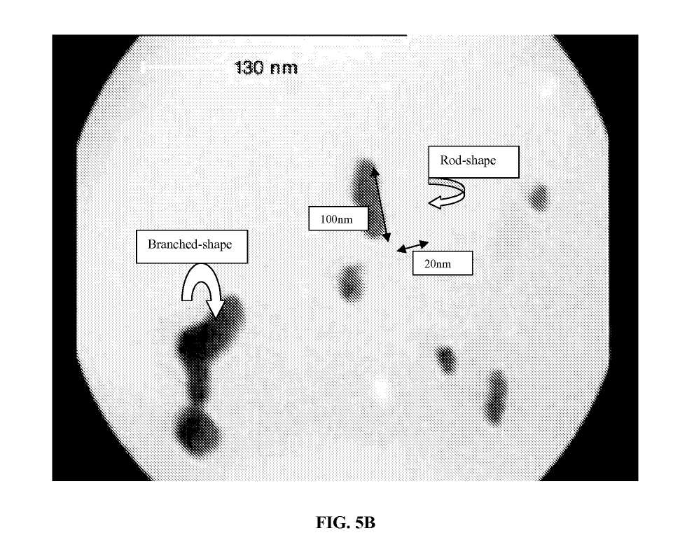

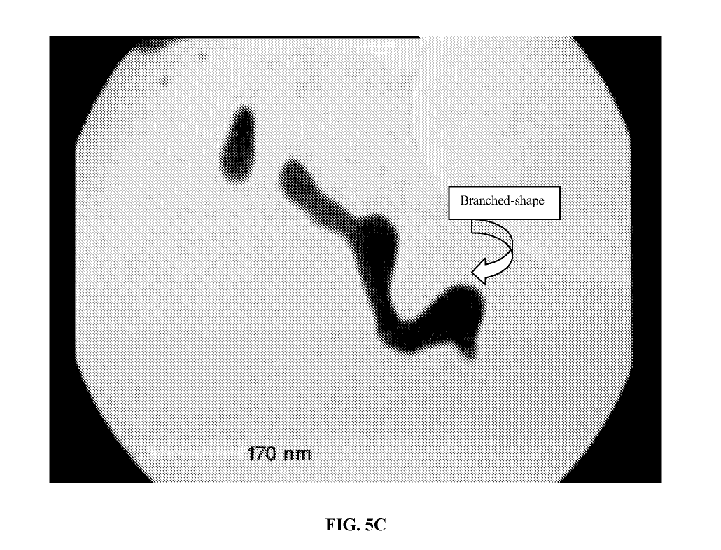

10 ml of 2.5 mM HAuCl4.3H2O was mixed with 500 ml polyethylene glycol 1000 and 1500 ml polyethylene glycol 2000 to form a mixture solution. The mixture solution was heated to 200° C. under microwave (MW) heating in a continuous wave (CW) or pulse mode 100% power of 2000 W for 3 min. Subsequently, the reducing solvent comprising the mixture of 500 ml PEG 400 and 500 ml propylene glycol 300 was heated to 200° C. under microwave (MW) in a continuous wave (CW) or pulse mode 100% power of 1000 W for 5 min. (visually, the color of the solution was changed to violet). After the reaction, the solution containing gold nanoparticles was cooled to room temperature. Ethanol was then added to precipitate gold nanoparticles. After washing several times with ethanol, the precipitated gold nanoparticles were collected for analysis. After 2 hours of the reaction, re-precipitation was performed using methanol or DI water. The nanostructures length and diameter was determined by transmission electron microscopy (TEM) (FIGS. 5A-5C). Gold salt solution and at least one of polyol act as the mixture solution and at least one of polyol compound act as the reducing solution, mixture solution and reducing solution separately are heated under microwave.

### EXAMPLE 4

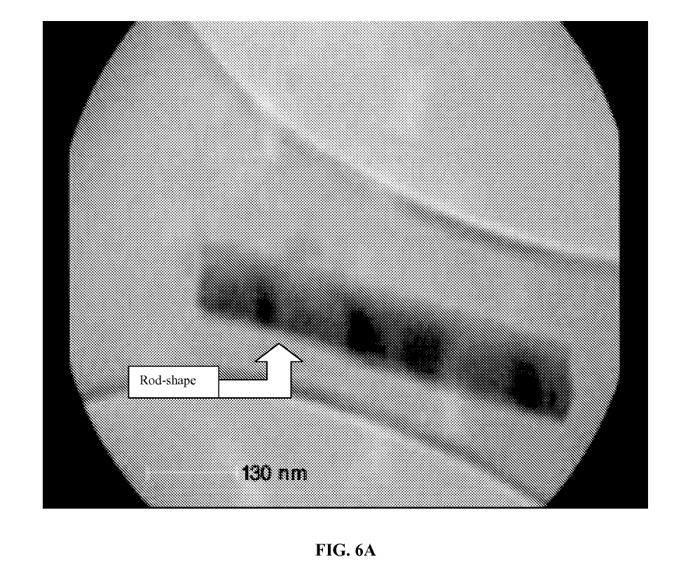

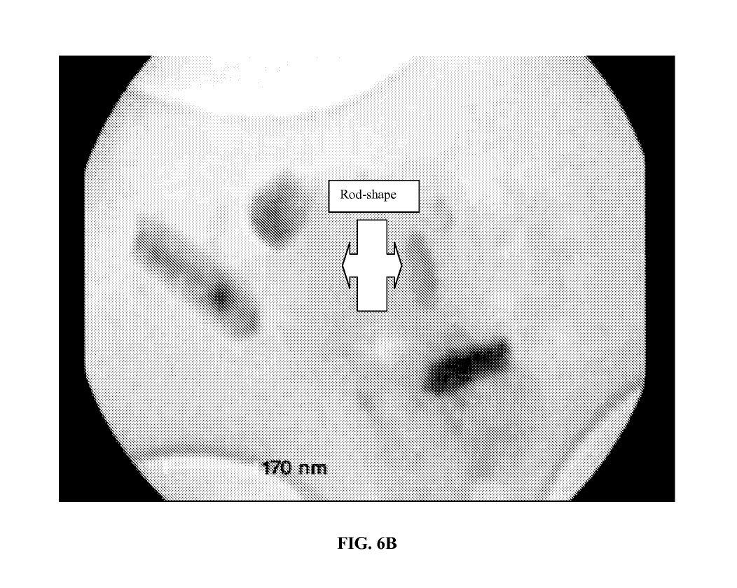

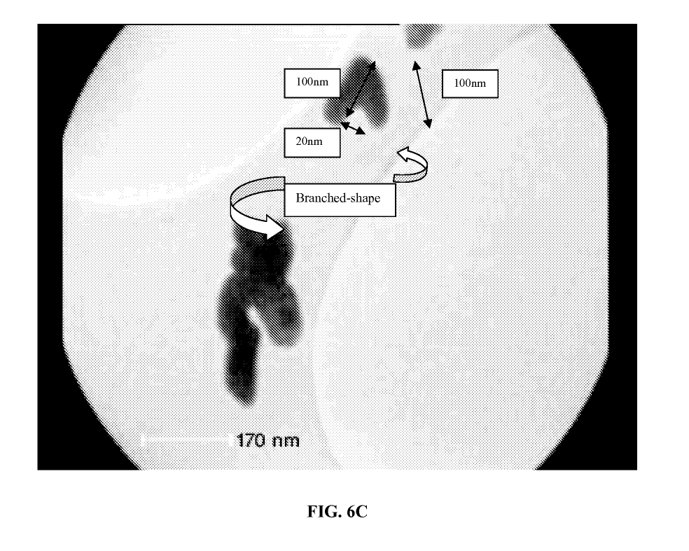

10 ml of 5 mM HAuCl4.3H2O was mixed with 1000 ml polyethylene glycol 400 and 1000 ml polyethylene glycol 2000 to form a mixture solution. The mixture solution was heated to 200° C. under microwave (MW) in a continuous wave (CW) or pulse mode 100% power of 600 W for 3 min. Subsequently, the reducing solvent comprising the mixture of 500 ml PEG 6000 and 500 ml PEG 2000 was heated to 250° C. under microwave (MW) heating in a continuous wave (CW) or pulse mode 100% power of 600 W for 5 min. (visually, the color of the solution was changed to blue). After the reaction, the solution containing gold nanoparticles was cooled to room temperature. Ethanol was then added to precipitate gold nanoparticles. After washing several times with ethanol, the precipitated gold nanoparticles were collected for analysis. After 2 hours of the reaction, re-precipitation was performed using methanol or DI water. The nanostructures length and diameter was determined by transmission electron microscopy (TEM) (FIGS. 6A-6C).

### EXAMPLE 5

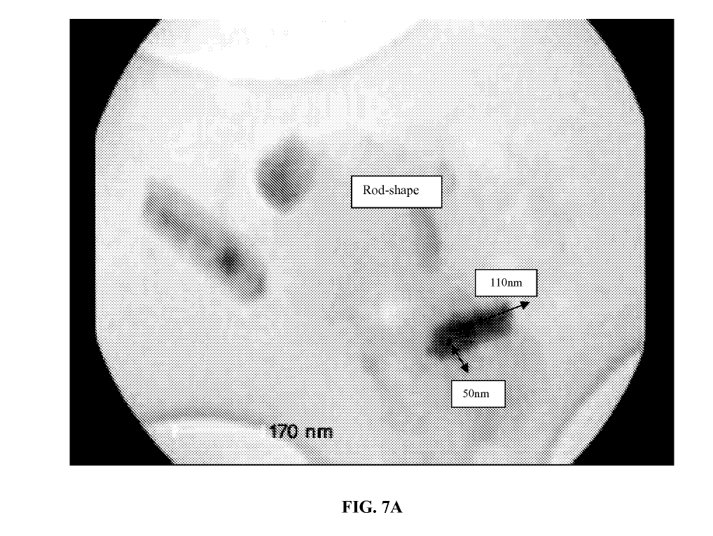

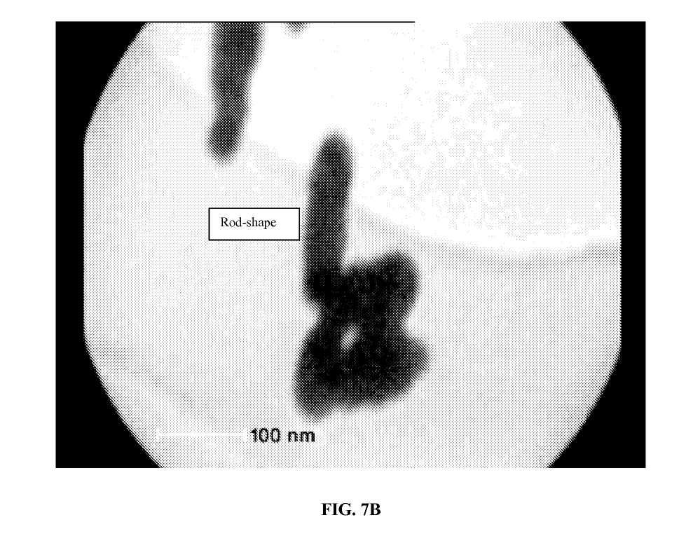

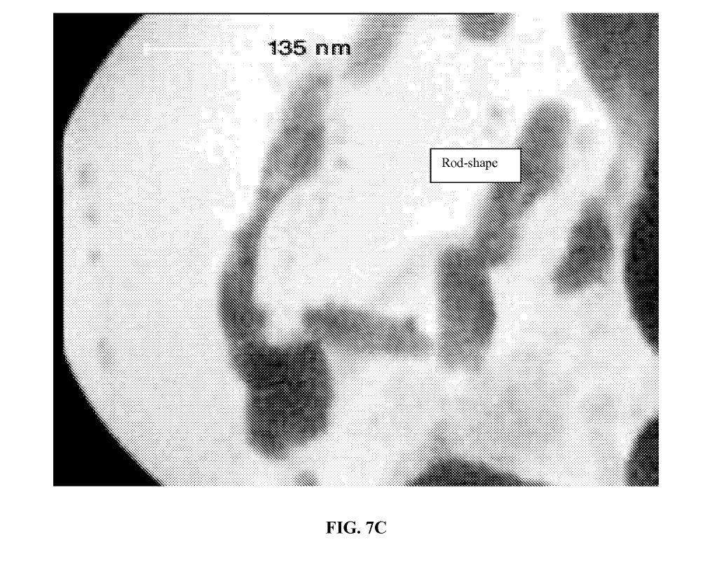

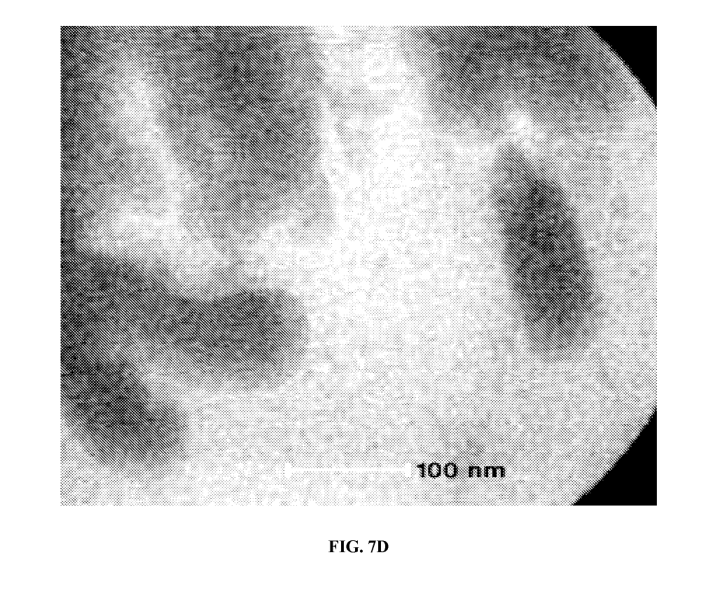

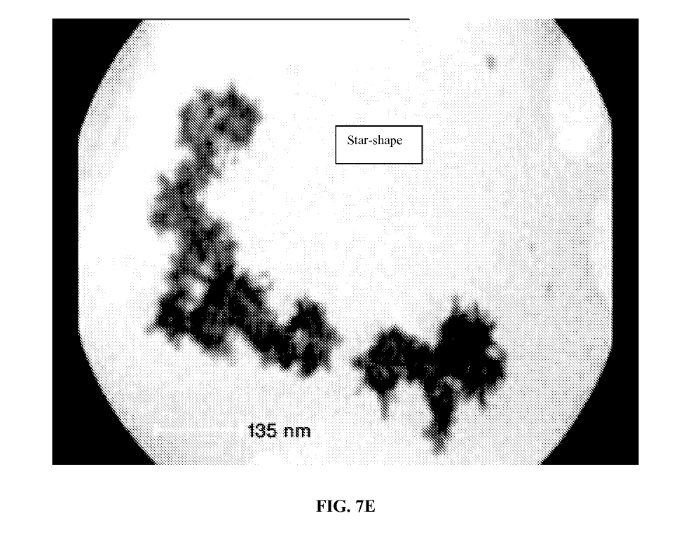

10 ml of 5 mM HAuCl4.3H2O was mixed with 1000 ml polyethylene glycol 400, 1000 ml polyethylene glycol 2000, polyethylene glycol 6000 to form a mixture solution. The mixture solution was heated to 250° C. under microwave (MW) in a continuous wave (CW) or pulse mode 100% power of 1000 W for 2 min. The reducing solvent comprising the mixture of 500 ml polyethylene glycol 6000, 500 ml polyethylene glycol 2000 and 500 ml polyethylene glycol 400 was heated to 200° C. under microwave (MW) in a continuous wave (CW) or pulse mode 100% power of 600 W for 5 min. (visually, the color of the solution was changed to blue). After the reaction, the solution containing gold nanoparticles was cooled to room temperature. Ethanol was then added to precipitate gold nanoparticles. After washing several times with ethanol, the precipitated gold nanoparticles were collected for analysis. After 2 hours of the reaction, re-precipitation was performed using methanol or DI water. The nanostructures length and diameter was determined by transmission electron microscopy (TEM) (FIGS. 7A-7E).

### EXAMPLE 6

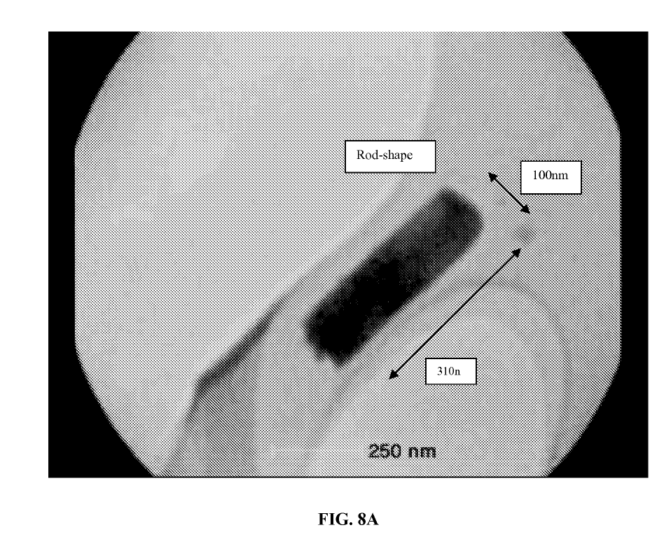

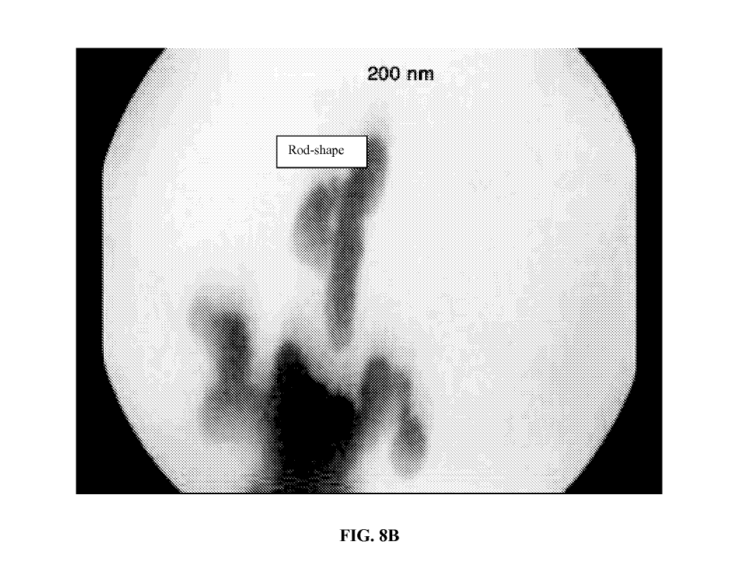

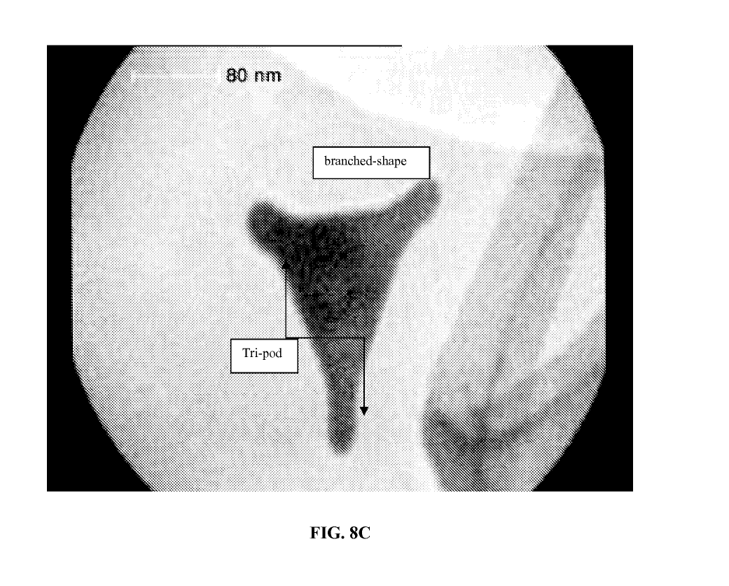

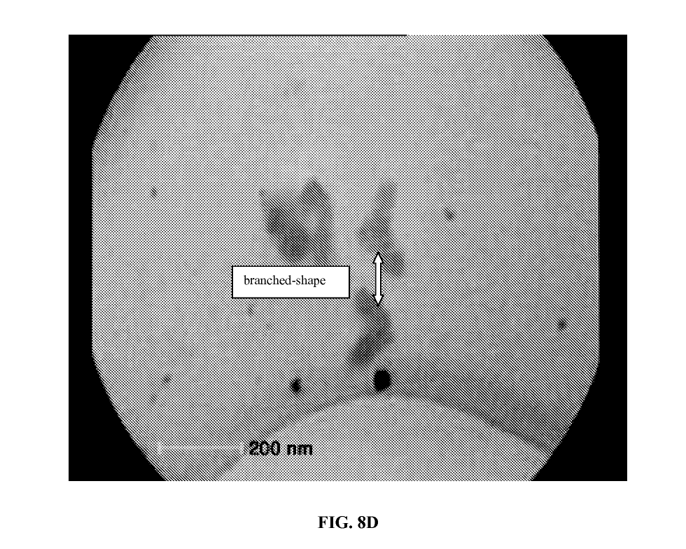

10 ml of 3 mM HAuCl4.3H2O was mixed with 1000 ml polyethylene glycol 400, 1000 ml polyethylene glycol 2000, 500 ml propylene glycol 300 to form a mixture solution. The mixture solution was heated to 185° C. under microwave (MW) in a continuous wave (CW) or pulse mode 100% power of 1000 W for 2 min. Subsequently, the reducing solvent comprising the mixture of 500 ml polyethylene glycol 6000, 500 ml polyethylene glycol 2000 and 200 ml polyethylene glycol 400 was heated to 150° C. under microwave (MW) in a continuous wave (CW) or pulse mode 100% power of 600 W for 5 min. (visually, the color of the solution was changed to blue). After the reaction, the solution containing gold nanoparticles was cooled to room temperature. Ethanol was then added to precipitate gold nanoparticles. After washing several times with ethanol, the precipitated gold nanoparticles were collected for analysis. After 2 hours of the reaction, re-precipitation was performed using methanol or DI water. The nanostructures length and diameter was determined by transmission electron microscopy (TEM) (FIGS. 8A-8D).

### EXAMPLE 7

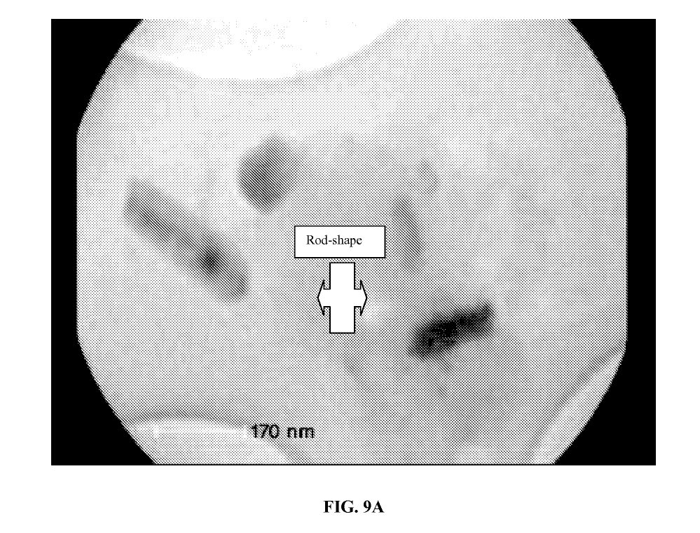

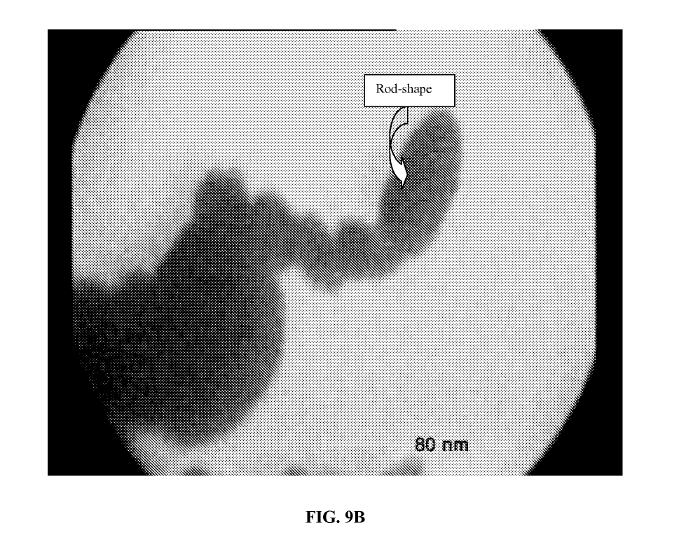

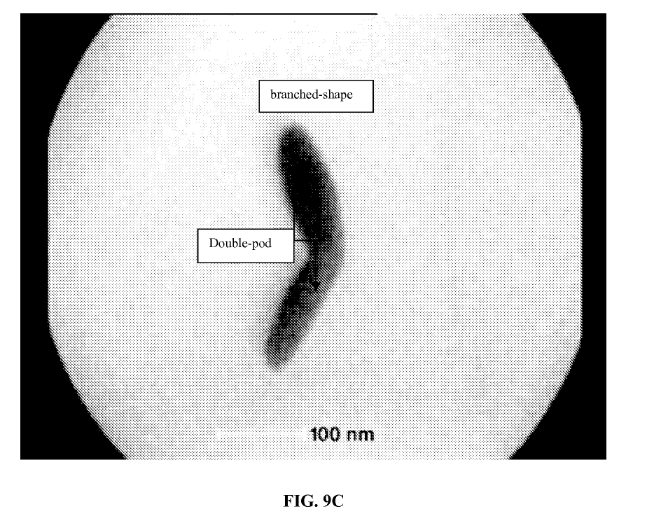

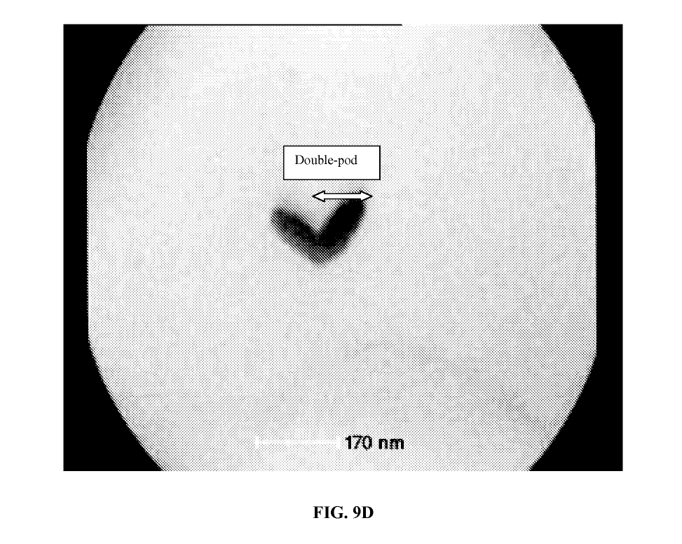

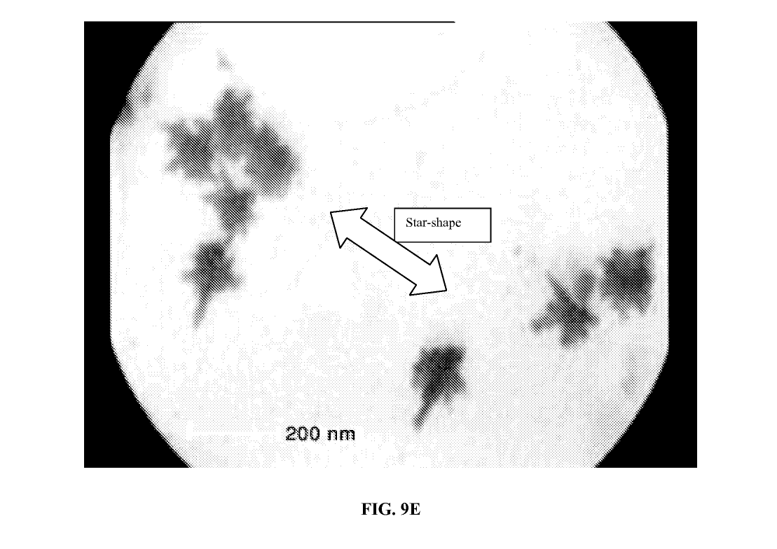

10 ml of 3 mM HAuCl4.3H2O was mixed with 1000 ml polyethylene glycol 400, 1000 ml polyethyleneglycol 2000, 500 ml propylene glycol 300, 1000 ml polyethylene glycol 4000, 500 ml polyethyleneglycol 6000 to form a mixture solution. The mixture solution was heated to 285° C. under microwave (MW) in a continuous wave (CW) or pulse mode 100% power of 600 W for 2 min. The color of the reaction solution was changed to green color. Subsequently, the reducing solvent comprising the mixture of 500 ml polyethylene glycol 6000, 500 ml polyethylene glycol 2000 and 200 ml polyethylene glycol 400 1000 mL, 500 ml polyethylene glycol 600 was heated to 200° C. under microwave (MW) in a continuous wave (CW) or pulse mode 100% power of 600 W for 5 min. (visually, the color of the solution was changed to blue). After the reaction, the solution containing gold nanoparticles was cooled to room temperature. Ethanol was then added to precipitate gold nanoparticles. After washing several times with ethanol, the precipitated gold nanoparticles were collected for analysis. After 2 hours of the reaction, re-precipitation was performed using methanol or DI water. The nanostructures length and diameter was determined by transmission electron microscopy (TEM) (FIGS. 9A-9E).

The embodiments herein are related to a metal nano-structures and the method of producing the same.

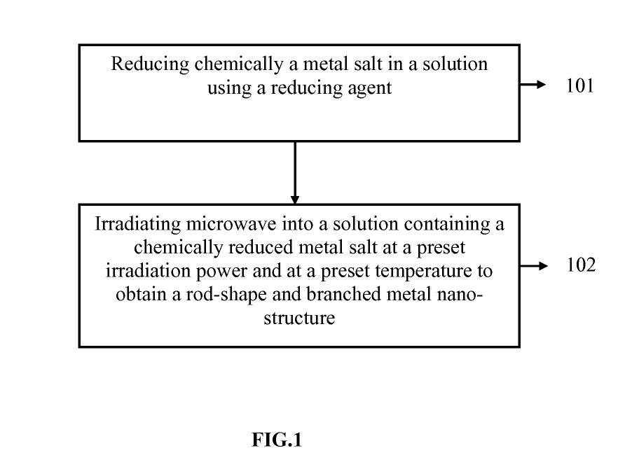

FIG. 1 illustrates a flow chart explaining the method of producing the rod-shape and branched metal nano-structures according to one embodiment herein. With respect to FIG. 1, the method of producing metal nano-structures involves reducing chemically a metal salt in a solution using a reducing agent as one step (101); and irradiating microwave into a solution containing a chemically reduced metal salt at a preset irradiation power and at a preset temperature as another step to obtain a rod-shape and branched metal nano-structure (102).

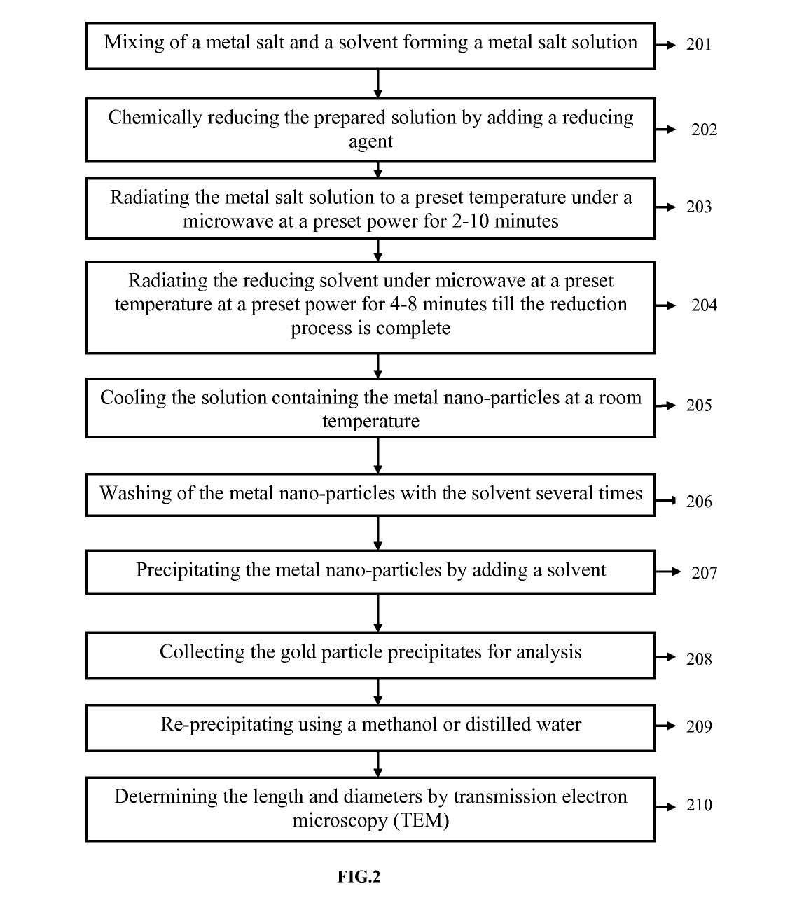

FIG. 2 illustrates a flow chart explaining the method of producing the rod-shape and branched metal nano-structures according to one embodiment herein. With respect to FIG. 2, the method of producing metal nano-structures involves mixing of a metal salt and a solvent forming a metal salt solution (201). Chemically reducing the prepared solution by adding a reducing agent (202). Radiating the metal salt solution to a preset temperature under a microwave in a continuous wave or pulse mode at a preset power for 2-10 minutes (203). Radiating the reducing solvent comprising of a mixture of polyol compounds under microwave at a preset temperature in a continuous wave or pulse mode at a preset power for 4-8 minutes till the reduction process is complete (204). The solution containing the metal nano-particles is cooled to a room temperature (205). Precipitating the metal nano-particles by adding a solvent (206). Washing of the metal nano-particles with the solvent several times (207). Collecting the gold particle precipitates for analysis (208). Re-precipitating using a methanol or distilled water (209), after 2 hours of duration of the reaction. Determining the length and diameters by transmission electron microscopy (TEM) (210).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method of producing a rod-shape and branched metal nano-structure, consisting of:
mixing a metal salt and a solvent to form a metal salt solution, wherein the metal salt solution is maintained at or below 50° C. or at an ambient temperature;
chemically reducing the metal salt solution by adding a reducing agent, wherein the reducing agent is a polyol compound with a chemical formula HO—CH2-(CH2-O—CH2-) n-CH2-OH—;
irradiating the metal salt solution using microwaves with preset power for heating the metal salt solution at a preset temperature for a preset time, to generate a rod shaped and branched metallic nano particles which exhibit multiple spectral resonances at microwave or radio frequencies, wherein the microwave is used in a pulse wave mode or in a continuous wave mode and wherein the preset power is within a range of 600 W-2200 W and wherein the preset temperature is within a range of 100° C.-340° C. and wherein the preset time is 2-30 minutes;
cooling the irradiated metal salt solution containing the metallic nano-particles at a room temperature;
precipitating the metallic nano-particles by adding a solvent;
washing the metallic nano-particles with the solvent several times;
collecting the precipitated metallic nano-particle precipitates for analysis; and
performing a re-precipitation of metallic nano particles using a methanol or distilled water.

2. The method according to claim 1, wherein the metal salt solution is irradiated with the microwave for 4-8 minutes till the reduction process is complete and the metal salt is completely reduced to generate metallic nano-particles.

3. The method according to claim 1, wherein the metal salt solution is irradiated with the microwave for preset time for solvothermally treating the mixture.

4. The method according to claim 1, wherein a configuration of the metallic nano-structures depends on a type of the polyol compound added, the amount of polyol compound added to the metal salt solution, a surfactant, an irradiation power of the microwave, an irradiation time of the microwave and an irradiation temperature.

5. The method according to claim 1, wherein the configuration of metallic nano-structures is a metallic nano-rod, a metallic nano-ellipsoid, a metallic nano-wire, a metallic nano-branched and a metallic nano-multi-pod.

6. The method according to claim 1, further comprises:
tuning a first plasmon-polariton resonance across a first axis of the rod shaped and branched metal nano-structures to a first wavelength; and
tuning a second plasmon-polariton resonance across a second axis of the rod shaped and branched metal nano-structures to a second wavelength.

7. The method according to claim 1, wherein the polyol compound has 2-6 hydroxyl groups and 2-12 carbon atoms.

8. The method according to claim 1, wherein the polyol compound is selected from a group consisting of a hydroxyl group and a carbon atom, a hetero-atom, an ether, an ester, an amine and/or an amide groups.

9. The method according to claim 1, wherein the polyol compound is selected from a group consisting of a polyester polyol, a polyether polyol, an aliphatic or a cycloaliphatic glycol, a corresponding glycol polyester or polyalkylene glycols.

10. The method according to claim 1, wherein the polyol compound is selected from a group consisting of an ethanediol, a propanediol, a butanediol, a pentanediol or a hexanediol, glycerol, trimethylolpropane, pentaerythritol, triethanolamine, trihydroxymethylaminomethane, glucose, ethylene glycol, diethylene glycol, tri-ethylene glycol, a propylene glycol, a dipropylene glycol or a polyethylene glycol, tetra-ethylene glycol, propanediol-1,2, di-propylene glycol, butanediol-1,2, butanediol-1,3, butanediol-1,4 and butanediol-2,3.

11. The method according to claim 1, wherein the polyol compound is selected such that a rod shaped and branched metallic nano structured precursors are non-volatile at a temperature in which the rod shaped and and branched metallic nano structured precursors are irradiated with microwaves.

12. The method according to claim 1, wherein the polyol compound is a polyethylene oxide compound and a combination thereof and the amount of the polyol compound added to the metal salt solution is within 500 mL-2000 mL.

13. The method according to claim 1, wherein the polyol compound is added to the metal salt solution to act as a reducing agent, to act as a stabilizer of metallic structures and to act as a substance to accelerate the major axis growth of the rod shaped and branched metallic nano structures.

14. The method according to claim 1, wherein the metal salt is selected from a group of compounds comprising of gold, copper, nickel, cobalt, platinum, palladium and their alloys.

15. The method according to claim 1, wherein the metal salt is selected from a group of gold compounds comprising of gold oxide, gold hydroxide, gold salts of inorganic and organic acids, nitrates, nitrites, sulfates, halides, carbonates, phosphates, azides, borates, sulfonates, carboxylates, formates, acetates, propionates, oxalates and citrates, substituted carboxylates, halogenocarboxylates, trifluoroacetates, aminocarboxylates, hydroxycarboxylates, hexachloroplatinates, tetrachloroaurate, tungstates, their corresponding acids, alkoxides, complex compounds of gold, beta-diketonates, complexes with amines, N-heterocyclic compounds, amino acids, amides, and nitriles and combinations thereof and wherein the molar concentration of the gold compound is within 0.1M-3.0M.

16. The method according to claim 1, wherein the solvent is a single solvent or a mixture of two or more solvents individually and a combination thereof.

17. The method according to claim 1, wherein the solvent is a single polyol or a mixture of polyols or one or more other solvents other than polyols.

18. The method according to claim 1, wherein the one or more other solvents other than polyols is selected from a group comprising of non-oxidative protic solvents or aprotic polar solvents.

19. The method according to claim 1, wherein the solvents is selected from a group comprising of aliphatic, cycloaliphatic and aromatic alcohols, ethanol, propanol, butanol, pentanol, cyclopentanol, hexanol, cyclohexanol, octanol, decanol, isodecanol, undecanol, dodecanol, benzyl alcohol, butyl carbitol and the terpineols, ether alcohols, C.sub.1-6 monoalkyl ethers of C.sub.1-6 alkanediols and polyetherdiols derived therefrom, monomethyl, monoethyl, monopropyl and monobutyl ethers of ethylene glycol, diethylene glycol, triethylene glycol, propylene glycol, dipropylene glycol, 1,3-propanediol, and 1,4-butanediol such as, e.g., 2-methoxyethanol, 2-ethoxyethanol, 2-propoxyethanol and 2-butoxyethanol, aminoalcohols, ethanolamine, amides, dimethylformamide, dimethylacetamide 2-pyrrolidone and N-methylpyrrolidone, esters, ethyl acetate and ethyl formate, sulfoxides, dimethylsulfoxide, ethers, tetrahydrofuran and tetrahydropyran, and water.

20. A method of producing a rod-shape and branched metal nano-structure, wherein the nano-structure is suitable as a coating composition material, a coating, a film, a wiring material, an electrode material, a catalyst, a colorant, a cosmetic, a near-infrared absorber, an anti-counterfeit ink and an electromagnetic shielding material, a surface enhanced fluorescent sensor, a biomarker and a nano-waveguide.
